(19) United States
(12) Patent Application Publication
(10) Pub. No.: US 2004/0104580 A1
(43) Pub. Date: Jun. 3, 2004

(54) Unit having a memory metal actuator for latching devices of household appliances

(76) Inventors: Georg Spiessl, Willhof-Altendorf (DE); Albert Dirnberger, Neunburg v.W. (DE); Josef Nothaas, Waffenbrunn (DE); Gunter Zuhlke, Stulln (DE)

Correspondence Address: Clifford W. Browning, Woodard, Emhardt, Naughton, Moriarty & McNett, Bank One Center/Tower, 111 Monument Circle, Suite 3700, Indianapolis, IN, 46204-5137, US

(21) Appl. No.: 10/375,282

(22) Filed: Feb. 27, 2003

(30) Foreign Application Priority Data
Feb. 27, 2002 (EP) 02 004 559.7

(51) Int. Cl. E05C 19/06

(52) U.S. Cl. 292/84

(57) ABSTRACT

The present invention provides a method for a door latch of a household appliance wherein the unit includes at least one memory metal actuator which generates forces desired during use of the door latch.

### DESCRIPTION

1. Field of the Invention

In general, the present invention relates to door latching devices for household appliances, such as washing machines, dishwashers and dryers. In particular, the present invention relates to means used in door latching devices for household appliances which generate forces during and/or for opening/closing and/or latching/unlatching household appliance doors.

2. Background of the Invention

In household appliances, such as washing machines, dishwashers, dryers, kitchen stoves, microwave devices and the like, for security purposes it is required that access means, such as appliances doors, shutters, covers, filling-in means and the like can be used only under certain circumstances. In general, for that purpose, latching units (in the following commonly referred to as door latches) are use for access means (in the following commonly referred to as appliances doors) for household appliances.

Door latches for household appliances are usually designed such that an opening, even only a partial opening, of an appliance door is not possible during operation of a household appliance in order, for example, to avoid that water escapes from a running washing machine. In general, this is accomplished by door latches for household appliances comprising units which are controlled in dependence of the operation condition of a household appliance such that an opening of appliances door is prevented. For example, this can be accomplished by the controlled units of a door latch prevent an unlatching of mechanical connections for maintaining an appliances door closed by means of respective engagements. In order to embody the respective engagements which prevent an unlatching of an appliances door, usually, moveable components are employed which can be operated by means of electrically and/or electronically controlled actuators. Examples for actuators used in household appliances are electric motors, electromagnet arrangements, bimetals and actuators comprising expandable materials (for example wax motors).

Further, in household appliances it is required that appliances doors cannot be opened even in unnormal operating conditions (for example power failure). Usually, this is accomplished by using means being referred to as emergency unlatching units in the following which take door latches, in or after an unnormal operating condition s of a household appliance, in a condition wherein the appliances doors can be opened. Examples for emergency unlatching units are mechanically operative means actuated by users of household appliances (for example cable or bowden pulleys), means having bimetallic actuators or actuators comprising elements of expandable material which, for a power failure due to the missing energy supply resulting therefrom, undergo a transition into a condition that allows an unlatching or opening, respectively, of appliances doors, and electric motor and electromagnet arrangements which, in case of an unnormal operating condition, are actuated via using an energy supply being independent of the actual energy supply of a household appliance.

The actuators usually used in door latches exhibit different drawbacks. Door latches wherein opening and unlatching, respectively, during operation is prevented by means of electric motors or electromagnets and/or emergency unlatching units thereof are operated by electric motors and electromagnets, respectively, have large dimensions due to the use of electric motors and electromagnets, respectively. Further, using electric motors and electromagnets in emergency unlatching units for door latches, it is required to provide additional means which supply energy to these actuators even in unnormal operating conditions. The use of actuators comprising bimetals and elements having expandable material has the drawback that these actuators exhibit relatively long response times, i.e. these actuators generate the desired forces only after a certain period of time has elapsed. In, case of emergency unlatching units having actuators comprising bimetals and elements of expandable material, respectively, the corresponding door latch is, for example after a power failure, released to be opened again after a period of time characteristic for the respectively used actuators including bimetals and elements of expandable material, respectively, has elapsed. For example, this can result that a washing machine can be opened after a power failure although water is still present in the appliance.

Further problems existing with household appliances is that household appliances doors should be securely closed during the operation of the household appliances in order, for example, to prevent an escape of water. In contrast thereto, household appliances doors should be closed and opened in a simple manner, i.e. with the smallest possible force effect involved for users. In order to fulfill these opposing requirements it is known to equip door latches for household appliances with arrangements of electric motors or electromagnets which support users in opening and closing of appliances doors by generating respective forces. Actuators comprising arrangements of bimetals and elements of expandable materials are not sufficient for that purpose because they cannot generate forces which are large enough to effectively support users in closing and opening of household appliances doors. Further, due to the use of electric motors and electromagnets, respectively, large dimensions of the door latches result.

### OBJECT OF THE INVENTION

In general, an object of the present invention is to solve the above mentioned problems of the prior art. In particular, the present invention should provide solutions which enable to generate forces which are desired for and/or during opening/closing and/or latching/unlatching of doors of household appliances of sufficient magnitude in order, for example, to secure doors of household appliances as regards an undesired opening (locking of door latches), which enable to release locked door latches in normal and unnormal operating conditions and which allow to support opening/closing procedures and/or latching/unlatching procedures of doors of household appliances and which have, at the same time, dimensions as small as possible.

### SOLUTION ACCORDING TO THE INVENTION

To solve the above mentioned object, the present invention is based on the approach to employ units in door latches for household appliances which comprises shape memory alloys also referred to as memory metals for generating forces during and/or for opening/closing and/or latching/unlatching of doors of household appliances.

The use of memory metals as actuators for door latches of doors of household appliances has several benefits. Memory metals can generate forces which are comparable with those of arrangements of electric motors and electromagnets, but exhibit dimensions which are significantly smaller than those of bimetallic actuators. For example, a wire, used as actuator, formed from memory metal of the type Nitinol (common but not protected name for memory metal from NiTi alloys) having a diameter of approximately 4 mm can generate forces of up to 100 Newton, i.e. a load of up to one ton can be moved.

A further benefit in comparison with bimetallic actuators the activatable movement thereof being limited to bending deformation only and in comparison with actuators comprising elements of expandable materials which can generate forces only effective in transversal direction, memory metal actuators can accomplish any movements for generation of forces. Accordingly, in the procedure according to the invention, it is not necessary any more to design door latches for household appliances in view of contemplated actuators. Rather, the memory metal actuators can be designed in view of a desired or given construction of a door latch thereby further enabling to integrate memory metal actuators in already existing door latches.

In principle, memory metals are differentiated in so called one-way memory metals and two-way memory metals. Irrespective of its shape in a temperature range below a threshold temperature, one-way memory metals take a given form in case the threshold temperature is exceeded wherein forces are generated. This action is repeatable by deforming one-way memory metals from the given shape by means of external forces and, then, by heating above the threshold temperature. Two-way memory metals exhibit two given shapes which are taken in falling below a lower and in excess, respectively, of an upper threshold temperature. For transitions between the two given shapes, it is not necessary that external forces act on two-way memory metals. Rather, it is sufficient to heat two-way memory metals above the upper threshold temperature and to cool down two-way memory metals below the lower threshold temperature in order to obtain their different shapes. Accordingly, using two-way memory metals, it is possible to generate forces both in excess of the upper threshold temperature and in falling below the lower threshold temperature, whereas in case of one-way memory metal forces are generated only in excess of the corresponding threshold temperature.

These properties of memory metals allow to employ memory metals actuators according to the present invention either in door latches which commonly comprise bimetallic actuators or actuators comprising elements of expandable material (i.e. actuators which generate forces in one direction) or door latches which so far comprise electric motor or electromagnet arrangements (i.e. means capable of generating forces in opposite directions). In addition, two-way memory metals allow, in contrast to electric motor and electromagnet arrangements, to generate forces in directions which do not act in opposite direction only but can have any relation with respect to each other. For example, by means of a two-way memory metal actuator it is possible to generate a first force acting in a first direction and a second force acting in a second direction, wherein the first and second directions can be selected to have any relation with respect to each other.

A further benefit of the memory metal actuators according to the present invention in contrast to conventional bimetallic actuators is that memory metal actuators exhibit a hysteresis which is why forces produced by memory metal actuators can be generated in a virtually step like manner. In contrast thereto, bimetal actuators generate forces which, in general, follow a linear function. As illustrated in FIGS. I 1a and I 1b this applies to both one-way and two-way memory metals.

### SHORT DESCRIPTION OF THE INVENTION

In particular, to solve the above mentioned object, the present invention provides a unit for a door latch of a household appliance according to claim 1. The unit according to the invention comprises at least one memory metal actuator which generates desired forces when using the door latch.

As set forth above, the memory metal actuator can serve to lock the door latch when it is in a latched condition, i.e. it can cooperate with the door latch such that the latter cannot be caused out of its latched condition by a user of the household appliance.

Further, the memory metal actuator can serve to cause the door latch from its latched condition in which it maintains a appliance door of the household appliance closed into an unlatched condition wherein the appliance door is not latched any more and not opened yet but wherein an opening of the appliance door is possible.

In order to make the opening of the appliance door of a household appliance particularly user friendly, it is contemplated that the memory metal actuator is adapted and arranged such that, for example after completion of an operational cycle of the household appliance, it causes the door latch in an opened condition wherein the appliance door is not only unlatched but also at least partially opened (“fly open of the appliance door”).

Comparable thereto, the closing process of an appliance door of a household appliance can be supported by the memory metal actuator, for example prior to an actual start of a household appliance, generating forces which cause the door latch from an opened position at least in its released position wherein the household appliance door is already closed but not latched yet. Preferable, the memory metal actuator generates forces during closing the door of a household appliance which are sufficient to cause the door latch from its open position into its latched condition wherein the door of the household appliance is closed and latched. This can also be used to maintain a door of a household appliance in its closed condition, for example, by providing by means of a memory metal actuator a contact force between the appliance door and a stop (e.g. sealing elements) or by increasing the contact force generated by other components (e.g. springs) cooperating with the door of the household appliance.

Depending of the type of desired forces to be generated by the memory metal actuator, a one-way or a two-way memory metal actuator can be used. Using a one-way memory metal actuator, it is contemplated that it cooperates with a reset unit of the door latch which is capable of generating forces that act in a direction being is opposite to the direction of the forces generated by the memory metal actuator. Examples for such reset units comprise elastic actuators, springs, bi-stable elements, hydraulic and pneumatic components and the like.

The design of the one-way memory metal actuator for cooperating with the reset unit of the door latch makes it possible to cause the one-way memory metal actuator, from its given shape which it takes upon excess of a respective threshold temperature, in a shape being different therefrom from which the one-way memory metal actuator takes the given form upon a respective heating and generates the desired forces.

Accordingly, by means of the contemplated combination of the memory metal actuator with a reset unit of the door latch, a back-shaping of the one-way memory metal actuator can occur without the need that a user of the household appliance must become active. The back-shaping of the one-way memory metal actuator can also occur via an action performed by a user when using a household appliance, for example upon opening/closing and/or latching/unlatching of the appliance door.

Using a two-way memory metal as actuator in the unit according to the invention, in general, a design of the memory metal actuator can be refrained from as regards a cooperation with a reset unit of the door latch as long as it is ensured that the excess of a first, upper threshold temperature and a second, lower threshold temperature, respectively, is guaranteed for an operation of the two-way memory metal actuator.

Further, using a two-way memory metal actuator, it is contemplated to adapt the two-way memory metal actuator as regards a cooperation with a reset unit of the door latch such that the actuator is caused into a neutral condition when its temperature is between the upper and lower threshold temperatures. Then, from such a neutral condition, the two-way memory metal actuator can, in dependence of operation conditions of the door latch and the household appliance, respectively, take a first shape for an excess of the upper threshold temperature or can take a given second shape for falling below the lower threshold temperature in order to generate forces accordingly.

For activation of the memory metal actuator, the unit can comprise a means in order to heat, preferably in dependence of operating conditions of the door latch and the household appliance, respectively, the actuator above a given threshold temperature in case of a one-way memory metal or above the upper threshold temperature in is case of a two-way memory metal. As an alternative or in addition thereto, it is contemplated that the unit according to the invention is adapted such that, for heating above the threshold temperature (one-way memory metal) or above the upper threshold temperature (two-way memory metal), temperature changes can be used which occur during operation of the household appliance. Examples are washing machines wherein a heating of the washing water is also used to heat the memory metal actuator. Examples for a heating integrally formed in the unit according to the invention, are PTC elements, heaters (preferably miniaturized heating elements) and a, preferably controlled, current flow through the memory metal actuator.

Further, it is contemplated that the processor required for heating the memory metal actuator occur in a pulse-like manner or continuously in order to generate, by means of the memory metal actuator, pulse-like forces prevailing for short periods of time or to generate forces acting over a longer period of time. Preferably for these operation modes of the unit according to the invention, control units integrally formed therein or a control unit of the door latch being adapted for that purpose are used.

In particular, the variations for controlling the unit according to the invention described in the following are contemplated. In order to heat a memory metal actuator of the unit according to the invention such that it takes a given shape and its maintained in this (heated) condition, the memory metal actuator can be directly driven with a current, preferably in a uniform and continuous manner. As an alternative or in addition thereto, the memory metal actuator can be indirectly driven in a continuous manner so, for example, by heating the memory metal actuator and maintaining the memory metal actuator heated by means of a thermically coupled PTC element.

For pulse-like driving, a current having a proper pulse like course can be used. Preferably, a pulse-like driving current is generated for the memory metal actuator by connecting the memory metal actuator with a PTC element in series. Due to the properties of PTC elements, in this manner a pulse-like driving current can be generated without a complex control. If PTC elements are supplied with energy, for example, by means of a voltage or current supply, initially PTC elements have a rather low ohmic resistance for a short period of time and subsequently undergo, in a virtually step-like manner, a transition to a condition having a very high ohmic resistance. This property allows to use PTC elements, comparable to a controlled energy supply or a switch, for a pulse-like driving of a memory metal actuator of the unit according to the invention. As an advantage thereof, a pulse-like driving results in a fast actuation of a memory metal actuator and, thus, to short activation and response times, respectively, of the unit according to the invention.

In order to maintain a memory metal actuator of the unit according to the invention, which is initially driven in pulse-like manner, in a condition in which it maintains its given shape, it is contemplated to maintain the memory metal actuator heated after an actuation. Using a controlled current supply, this can be accomplished by directly driving and heating; respectively, the memory metal actuator with an essentially constant current after a pulse-like driving. Using a PTC element for a pulse-like actuation of a memory metal actuator of the unit according to the invention, it is contemplated to also use the PTC element, as described above, to heat the memory metal actuator by means of a thermal coupling. Also, for a pulse-like driving by means of a PTC element, after a pulse-like activation of a memory metal actuator of the unit according to the invention, the heating can be performed by means of a controlled, essentially constant current supply to the memory metal actuator.

Furthermore, it is contemplated that a memory metal actuator of the unit according to the invention cooperates with a means which, subsequently an acivation of the memory metal actuator, maintains the condition effected by the same. Examples for such a means are connecting link guides, releasable click and/or snap connections and the like. The use of such means has the advantage that, subsequent to an activation of a memory metal actuator of the unit according to the invention, a condition effected by the same (for example latching or unlatching of a door latch) can be maintained essentially independent of the fact whether the memory metal actuator remains activated (heated). If, for example, a memory metal actuator being driven in pulse-like manner is used in the unit according to the invention, thus, it is not necessary any more to further heat the memory metal actuator subsequently to a condition change of the unit according to the invention effected by a pulse-like driving of the memory metal actuator.

Moreover, this procedure allows to realize, by means of a one-way memory metal actuator, transmissions between different operating conditions of the unit according to the invention for which otherwise two-way memory metal actuators or a further one-way memory metal actuator would be necessary. For example, by means of a connecting link guide cooperating with a one-way memory metal actuator, it is possible to latch and unlatch a door latch by means of a pulse-like driving of the unit according to the invention. For example, a first pulse for actuation of the one-way memory metal actuator can cause the unit according to the invention into an operation condition in which it is capable to latch a door latch of a household appliance. By means of a connecting link guide, this operation condition can be maintained until the one-way memory metal actuator is further operated by means of a second pulse in order to cause the unit according to the invention in an operation condition for unlatching the door latch. Then, again by means of the connecting link guide, this unlatched condition can be maintained.

Further, for solution of the above mentioned object, the present invention provides a door latch which comprises an embodiment of the above mentioned unit according to the invention and which is adapted for operation therewith.

In addition, the present invention provides memory metal actuators which are adapted for use in the above mentioned unit according to the invention. In particular, the memory metal actuators according to the invention can comprise single or several memory metal wires or exhibit the shape of bending beams or form parts.

### SHORT DESCRIPTION OF THE FIGURES

In the following description of preferred embodiments, it is referred to the enclosed figures which show:

FIGS. I 1a and I 1b schematic illustrations of changes of one-way and two-way memory metals in dependence of the temperature in comparison with temperature dependent variations of bimetals,

FIGS. I 2a and I 2b schematic illustrations of arrangements for operation of units according to the invention,

FIGS. I 3a and I 3b schematic illustrations further arrangements for operation of units according to the invention,

FIGS. II 1a and II 1b schematic illustrations of a first embodiment of a door latch according to the invention having a one-way memory metal actuator,

FIGS. II 2a and II 2b schematic illustrations of the first embodiment having a two-way memory metal actuator,

FIG. III 1 a schematic illustration of the second embodiment of a door latch according to the invention having a memory metal actuator to be driven in pulse-like manner,

FIGS. III 2a and III 2b schematic illustrations of variations of the second embodiment,

FIG. III 3 a schematic illustration of a third embodiment of a door latch according to the invention,

FIGS. IV 1a to IV 1c schematic illustrations of a fourth embodiment of a door latch according to the invention having a memory metal actuator to be driven in continuous manner,

FIGS. IV 2a to IV 2c schematic illustrations of a fifth embodiment of a door latch according to the invention having a memory metal actuator to be driven in pulse-like manner and a connecting link guide cooperating therewith,

FIGS. V 1a and V 1b schematic illustrations of a sixth embodiment of a door latch according to the invention for actively closing of a door of a household appliance having a memory metal actuator to be driven in continuous manner,

FIGS. V 2a and V 2b schematic illustrations of a seventh embodiment of a door latch according to the invention for actively pulling a door of a household appliance having a memory metal actuator to be driven in pulse-like manner and a connecting link guide cooperating therewith,

FIGS. VI 1a and VI 1b schematic illustrations of an eighth embodiment of a door latch according to the invention,

FIGS. VI 2a and VI 2b schematic illustrations of a modification of the eighth embodiment,

FIGS. VI 3a and VI 3b schematic illustrations of a further modification of the eighth embodiment having a memory metal actuator to be driven in pulse-like manner and a connecting link guide cooperating therewith,

FIG. VII 1a a schematic illustration of a ninth embodiment of a door latch according to the invention in the open position,

FIG. VII 1b a schematic illustration of the embodiment of FIG. VII 1a in the closed position.

FIGS. VIII 1 to VIII 4 schematic illustrations of a tenth embodiment of a door latch according to the invention in different operation positions,

FIGS. VIII 5 and VIII 6 schematic illustrations which illustrate the cooperation of the embodiment according to FIGS. VIII 1 to VIII 4 with a door hook in two different operation positions,

FIG. VIII 7 a schematic illustration of an eleventh embodiment of a door latch according to the invention,

FIG. VIII 8 a schematic illustration of a twelfth embodiment of a door latch according to the invention,

FIG. VIII 9 a schematic illustration which illustrates the closed position of a door hook in the embodiment according to FIG. VIII 8,

FIG. IX 1 a schematic side view partially cut in longitudinal direction of a thirteenth embodiment of a door latch according to the invention in an at-rest position,

FIG. IX 2 a schematic illustration of the embodiment according to FIG. IX 1 in a closed position,

FIG. IX 3 a schematic illustration of the embodiment according to FIG. IX 1 in a released position,

FIG. IX 4 a schematic illustration of the embodiment according to FIG. IX 1 in an open position,

FIG. IX 5 a schematic illustration of the embodiment according to FIG. IX 1 in a first knee test position,

FIG. IX 6 a schematic illustration of the embodiment according to FIG. IX 1 in a second knee test position,

FIG. X 1 a schematic cross-sectional view of a fourteenth embodiment of a door latch according to the invention having an open door in a unlatched condition,

FIG. X 2 a schematic cross-sectional view of the embodiment according to FIG. X 1 for the door being closed and latched,

FIG. X 3 a schematic cross-sectional view of the embodiment according to FIG. X 1 for a the door being closed and electrically unlatched,

FIGS. XI 1a to XI 1d schematic illustrations of a fifteenth embodiment of a door latch according to the invention,

FIGS. XI 2a to XI 2d schematic illustrations of a sixteenth embodiment of a door latch according to the invention,

FIG. XI 3 a schematic illustration of a connecting link guide used in the embodiment according to FIGS. XI 2a to XI 2d

FIG. XI 4a to XI 4f schematic illustrations of a seventeenth embodiment of a door latch according to the invention, and

FIG. XI 5 a perspective view of a connecting link guide used in the embodiment according to FIGS. XI 4a to XI 4f.

### DESCRIPTION OF PREFERRED EMBODIMENTS

General Remarks

The description of preferred embodiments is divided in sections being referenced with Roman numerals wherein the figures associated to the different sections are provided with the respective Roman numerals followed by a consecutive numbering in Arabic numerals. Further, the reference numerals given in the single sections have been given independent in respect to each other.

Embodiments—Part I

In the units defined as door latches at the beginning, memory metal actuators are used wherein a memory metal actuator is meant as a unit which generates forces by means of a memory metal, in particular by means of its temperature dependent shape variation. Accordingly, here, memory metal actuators comprise several or bundled memory metal wires, units comprising the same, unit comprising components made from memory metal, memory metal components in the shape of bending beams, bodies and the like.

Further, in the following, activation of a memory metal actuator is meant such that the memory metal actuator is heated such that, in case of an one-way memory metal actuator, its threshold temperature and, in case of a two-way memory metal actuator, its upper threshold temperature is exceeded wherein occurring shape changes and forces associated therewith, respectively, are employed.

In order to heat at least the memory metal itself for activation of memory metal actuators, the memory metal actuator can be directly connected to a current or voltage source. Here, for activation, a control is used for the current or voltage source in order to generate a desired heating of the memory metal without damaging the same. This arrangement is schematically illustrated in FIG. I 2a.

As can be seen in FIG. I 2b, an activation of memory metal actuator can also be obtained by means of a thermal element (PTC element) which is thermically coupled to the memory metal actuator and which is controlled in dependence of the type of forces to be generated by the memory metal actuator. In a non-illustrated embodiment, a thermal element for activation of a memory metal actuator is used which provides its heating as soon as the household appliance is started. For example, this can be accomplished in that the thermal element is coupled to and supplied from, respectively, the energy supply of the household appliance.

Further, it is possible, to employ heat for activation of memory metal actuators which is produced in operation of a household appliance anyhow. Examples hereof are the heat radiation generated by heating elements of a washing machine or a dishwasher, heat occurring during the operation of a kitchen stove, heat generated during operation of a household appliance from moveable parts thereof and the like. In case of a household appliance utilizing microwaves, it is further possible to couple a memory metal actuator with a material which can be heated by the used microwave radiation in a manner to effect, during operation, i.e. during generation of microwaves, an activation of the memory metal actuator.

A particularly preferred embodiment for activation of a memory metal actuator is an arrangement shown in FIG. I 3a wherein the memory metal actuator being connected with a PTC element in series is supplied with energy. Here, the fact is used that PTC elements, if being connected with a current supply for activating/heating, have a very low ohmic resistance for a short period of time upon turning on the current supply and, subsequently, undergo a transition into a condition having a very high ohmic resistance in a virtually step-like manner. Accordingly, a current course is obtained which initially comprises a short pulse-like high current followed by an essentially constant low current. For a connection of a PTC element and the memory metal actuator in series, this results that the memory metal actuator is activted by the pulse-like current for a short period of time and, thus, that pulse-like forces are generated.

By means of a suitable selection of a PTC element and its voltage supply, it is possible to accomplish that, subsequent to the initial current pulse, the flowing current is low such that it is not sufficient for an activation of the memory metal actuator any more. Accordingly, subsequent to the activation by the current pulse, the memory metal actuator can cool, i.e. the memory metal actuator is deactivated. In that approach, the PTC element being connected in series with the memory metal actuator acts comparable to a switch whereby a complex control conventionally required for generating pulse-like currents is avoided.

Further, it is possible to arrange the PTC element being connected in series with the memory metal actuator such that the PTC element is also thermically coupled to the memory metal actuator. This procedure being illustrated in FIG. I 3b makes it possible to maintain, subsequent to an activation of the memory metal actuator effected by the initial current pulse, the memory metal actuator activated, i.e. to maintain it warm enough, such that it maintains the shape given for its activation (i.e. access of the threshold temperature) and maintains the forces associated thereto, respectively. As set forth above, subsequent to a pulse-like activation by means of a direct driving with a suitably controlled current, the heating of the memory metal actuator can be maintained.

Further, it is possible, as set forth at the beginning, to maintain an operation condition taken subsequent to a pulse-like activation of the memory metal actuator by, for example, a PTC element or a connecting link guide cooperating with the memory metal actuator.

As an alternative thereto, a thermal coupling of the PTC element with the memory metal actuator can be adapted such that the period of time up to a deactivation of the memory metal actuator is set to a desired or given, respectively, value. For that purpose, the heat applied from the PTC element to the memory metal actuator is selected such that its cooling process is retarded such that the deactivation (resetting, back-shaping) of the memory metal actuator just occurs after a desired and given, respectively, period of time.

In both cases, the thermal coupling of the PTC element to the memory metal actuator also provides for enhanced security. In case, for a unnormal operation condition, for example for a power failure, the PTC element is not supplied with energy any more, i.e. is not heated any more, the heat emitted in the cooling down process of the PTC element to the memory metal actuator provides that its deactivation is retarded. In this manner it is possible, for example, to release in case of a failure of a household appliance its door latch only after a certain period of time for unlatching has elapsed which can be adjusted by means of the cooling processes of the PTC element and the memory metal actuator.

For deactivation of a memory metal actuator, in case of a one-way memory metal actuator, it is operated such that its temperature falls below the corresponding threshold temperature after which a one-way memory metal actuator can be deformed in any desired manner by external forces ( e.g. spring forces). For a two-way memory metal actuator, a deactivation is meant as an operation of the actuator wherein the-two-way memory metal actuator is brought to a temperature below the corresponding lower threshold temperature.

In any cases, the memory metal actuator is to be cooled for a deactivation. In dependence, for example, of thermal properties of used memory metals and of a period of time given and/or desired for deactivation, as easiest case, a deactivation can occur by cooling the memory metal actuator by itself. In order to accelerate a deactivation, active elements, such as blowers or other cooling components, can be used. In case cooling means are already existing or cooling operation conditions are provided in the concerned household appliance, it is advantageous to use the same also for cooling the memory metal actuators. An example are dryers which, in general, employ air to cool laundry subsequent to completion of a drying program in order to avoid creasing of the laundry. This cooling air can also be used, if desired, to deactivate memory metal actuators.

Embodiments—Part II

In FIGS. II 1a and II 1b, a door latch for household appliance is illustrated which comprises a housing 10, a latching slider 12 and a closing hook 16 being arranged rotatably about an axle 14. On one end, the closing hook 16 includes a nose 18 and the closing hook 16 is biased to the left in the position shown in the figures by means of a not illustrated spring. The latching slider 12 cooperates with a compression spring 20. After closing a not illustrated appliance door which comprises the closing hook 16, the door latch takes the condition shown in FIG. II 1a. Closing the appliance door, the closing hook 16 is moved through an opening 22 in the housing 10 wherein a surface 24 of the nose 18 slides along a surface 26 of the housing 10 inwards and is guided through an opening 28 formed in the latching slider 12. When the nose 18 has passed the opening 22, the closing hook 16 moves into the biased position illustrated in the figures. Here, the latching slider 12 is moved in opposite direction to the right by means of the forces generated by the compression spring 20.

Further, the door latch comprises a locking slider 30 having an opening 32 formed therein through which a one-way memory actuator 34 is guided. The memory metal actuator 34 is mounted with one end 36 to the housing 10 and cooperates, with an end 38, with a tension spring 40. In the activated condition of the memory metal actuator 34, which is not illustrated in FIG. II 2a, the tension spring 40 maintains the memory metal actuator 34 and, as a result, the locking slider 30 in the positions shown there.

In order to latch the door latch, i.e. to ensure that the closing hook 16 cannot be moved from the position shown in FIG. II 1a, the locking slider 30 is, as illustrated in FIG. II 1b, guided, at least partially, through an opening 42 in the latching slider 12. Thereby, movements of the latching slider 12 are prevented.

For moving the locking slider 30 in the position shown in FIG. II 1b, the memory metal actuator 34 is activated wherein it takes the shape illustrated there. The memory metal actuator 34 can be activated in pulse-like manner and can be maintained in heated condition, in which the memory metal actuator 34 maintains the shape shown in FIG. II 1b, for example, as describe above, by means of a PTC element 44.

In order to unlatch the door latch, the memory metal actuator 34 is deactivated and the tension spring 40 provides for a transition of the locking slider 30 in the position shown in FIG. II 1a. Then, the closing hook 16 can be removed through the opening 22 from the housing 10 if, during opening the not illustrated household appliance door, the closing hook 16 is rotated in clockwise direction and the latching slider 12 is moved at the same time so far to the left that the nose 18 can be moved out of the opening 28 and through the opening 22.

The variation of the door latch illustrated in FIGS. II 2a and II 2b comprises, in place of the one-way memory metal actuator 34, a two-way memory metal actuator 46 which takes in cooled condition, i.e. below its lower threshold temperature, the position shown in FIG. II 2a. Accordingly, the tension spring 40 is not necessary here.

In order to achieve the latched condition of the door latch illustrated in FIG. II 2b, the two-way memory metal actuator 46 is (maintained) heated above its upper threshold temperature by means of the PTC element 44. The engagement of the locking slider 30 with the latching slider 12 is maintained by a respectively continued activation of the two-way memory metal actuator 46. For unlatching the door latch, the two-way memory metal actuator 46 is cooled below its lower threshold temperature, for example, by turning off the PTC element 44. After falling below its lower threshold temperature, the two-way memory metal actuator 46 takes the shape illustrated in FIG. II 2a wherein the locking slider 30 is moved upwards and the latching slider 12 is released.

Embodiments—Part III

The door latch illustrated in FIG. III 1 comprises a housing 10, a latching slider 12 and a closing hook 14 having a nose 16 formed for cooperation with the latching slider 12. The latching slider 12 is engaged by a compression spring 18 and is moved, upon closing a not illustrated household appliance door comprising the closing hook 14, against the compression spring 18 to the right. For that purpose, the nose 16 comprises a guiding surface 20 which moves the latching slider 12 to the right upon closing. In case, the closing hook 14 is moved far enough into the housing 10 such that the nose 16 has completely passed the latching slider 12 according to FIG. III 1, the compression spring 18 moves the latching slider 12 to the left. Thereby, the closing hook 16 cannot be removed from the housing 10 any more and the door latch is latched. In this embodiment, the latching of the door latch automatically occurs upon closing the household appliance door by a user.

For unlatching the door latch, a one-way memory metal actuator 22 is activated in order to move the latching slider 12 to the right and to release the closing hook 14. An advantage of that door latch is that, comparable to the combined closing and latching process, the unlatching and opening occurs cooperatively. For that purpose, a compression spring 24 is provided which engages the closing hook 14 and moves the same, upon an activation of the memory metal actuator 22, downwards at least such that the latching slider 12 cannot cooperate with the nose 16 for latching any more. Accordingly, it is only necessary to activate the memory metal actuator 22 until the compression spring 24 has moved the closing hook 14 downwards far enough. Then, the latching slider 12 can be moved via the guiding surface 20 of the nose 16 due to the force effect of the compression spring 18 whereby the closing hook 14 is further moved downwards. In this manner it is possible not only to unlatch the door latch but also to effect an actual, at least partial, opening of the household appliance door.

FIGS. III 2a and III 2b show arrangements for the door latch according to FIG. III 1 wherein the memory metal actuator 22 cooperates with the latching slider 12 by means of an intermediate lever 26. In the arrangement illustrated in FIG. III 2a, a force translation is realized via the intermediate lever 26 whereas in the arrangement shown in FIG. III 2b a path translation is obtained.

The door latch illustrated in FIG. III 3 comprises a housing 10, a latching slider 12, a bolt nab 14 being connected to a not illustrated household appliance door and a rotation latch 16. The rotation latch 16 is supported rotatably around an axle 18 and is biased in opening direction (here in clockwise direction) by means of a not illustrated spring. The latching lever 12 is engaged by a compression spring 20 which abuts on a stop 22 formed on the housing 10.

Upon closing the household appliance door, the bolt nab 14 is inserted into a recess 24 of the rotation latch 16 and is moved upwards whereby the rotation latch 16 is moved, in anti-clockwise direction, in the position shown in FIG. III 3. During the rotation of the rotation latch 16, a guiding surface 26 of the rotation latch 16 moves the latching lever 12 against the compression spring 20 to the right. In case, the rotation latch 16 is in the position shown in FIG. III 3, the compression spring 20 moves the latching lever 12 again to the right and prevents due to an engagement of a stop surface 28 of the latching lever 12 with a surface 30 of the rotation latch 16 that the latter one can be rotated in opening direction, i.e. in clockwise direction. Thus, the household appliance door is closed and the door latch is latched. Comparable to the embodiment according to FIG. III 1, here again a combined closing and latching action occurs.

For unlatching the door latch and for at least partially opening of the household appliance door, a memory metal actuator 32 is actuated in pulse-like manner in order to move the latching lever 12 to the right. Thereby, the rotation latch 16 is released and moved in opening direction, i.e. in clockwise direction, due to the not illustrated biasing spring. Thereby, the bolt nab block 14 is moved downwards and the household appliance door it at least partially opened.

Embodiments—Part IV

The door latch illustrated in FIGS. IV 1a to IV 1c comprises a housing 10, a rotation latch 14 being supported rotatably about on an axle 12 and a bolt nab 16 being attached to a not illustrated household appliance door. Between the rotation latch 14 and a lever 20 being arranged rotatably about an axle 18, a compression spring 22 is arranged. The compression spring 22 is connected to the rotation latch 14 such that the compression spring 22 maintains the rotation latch 14 in the position shown in FIG. IV 1a and is caused upon a rotation of the rotation latch 14 in clockwise direction, in the position shown in FIG. IX 1b. During such a rotation of the rotation latch 14, a snap point for the compression spring 22 is overcome such that the compression spring 22 snaps in the position shown in FIG. IV 1b and maintains the rotation latch 14 in the position shown in FIG. IV 1b. The same respectively applies for a rotation of the rotation latch 14 in anti-clockwise direction. Advantageously, the forces generated by the compression spring 22 in the two positions and the forces required to overcome the snap point are dimensioned such that the rotation latch 14 can be easily moved during closing and opening of the household appliance door.

For closing the household appliance door, the bolt nab 16 is moved into engagement with a recess 24 formed in the rotation latch 14 and the rotation latch 14 is rotated in clockwise direction. Having overcome the snap point, the forces provided by the compression spring 22 support the closing process at least partially. After completion of the closing process, the forces, which are generated by the compression spring 22 in the position shown in FIG. IV 1b, effect that the household appliance door is maintained closed by a given force. Advantageously, as set for the above, this force also referred to a contact force is dimensioned such that the household appliance door can be opened without a high force effort for the user.

In order to maintain, during operation of the household appliance, its door securely closed, the contact force generated by the compression spring 22 is increased by moving the lever 20 in the position shown in FIG. IV 1c. For that purpose, a one-way memory metal actuator 26 is activated which engages an end 30 of the lever 20 and moves the same to the left after activation. Thereby, the compression spring 22 is compressed and the contact force generated by the same increased. This condition is maintained by means of a driving mode for the memory metal actuator 28 explained at the beginning. Here, it is contemplated that the thusly increased contact force is large to an extent that, during an operation condition of the household appliance wherein the household appliance door is not be opened, an opening of the household appliance door is prevented or only possible with a (significantly remarkably) increased force effort.

For operation conditions of the household appliance wherein the household appliance door is allowed to be opened, the memory metal actuator 28 is deactivated and the compression spring 22 moves the lever 20 back in the position illustrated in FIG. IV 1b. The thusly reduced contact force allows an easy opening of the appliance door.

In the variation illustrated in FIGS. IV 2a to IV 2c it is not necessary to activate the memory metal actuator 28 in a continuous manner in order to maintain the lever 20 in the inclined position necessary for increasing the contact force. For that purpose, a connecting link guide 32 cooperating with the lever 20 is used which includes a guiding groove 34 formed therein in which a not illustrated guiding pin arranged on lever 20 can be moved. In case, a contact force is to be increased for an operation condition of the household appliance, i.e. the lever 20 is to be inclined to the left and to be maintained in that position, the memory metal actuator 28 is activated in pulse-like manner. Upon the thusly effected inclination movement of the lever 20, its guiding pin moves to the left in the guiding groove 34 until a groove portion 36 or a groove portion 38 is reached. After the pulse-like activation of the memory metal actuator 28, the compression spring 22 pushes the lever 20 a bit to the right wherein the guiding pin reaches a groove portion 44 due to the force generated by a spring 40 and rotating the connecting link guide 32 about an axle 42. Depending of the spring 40 being a compression spring or being a tension spring, here, the connecting link guide is rotated in clockwise direction or in anti-clockwise direction. As the guiding pin of the lever 20 is in the groove portion 44, the lever 20 is maintained in is the position shown in FIG. IV 2c.

In order to cause the lever 20 out of its inclined position and to thusly reduce the contact force, the memory metal actuator 28 is further activated in pulse-like manner. Initially, this effects a stronger inclination of the lever 20 to the left such that its guiding pin gets to the groove portion 38 or to the groove portion 36. After completion of the activation of the memory metal actuator 28, the compression spring 22 pushes the lever 20 back to the right in its starting position wherein the guiding pin of the lever 20 moves back in the guiding groove 34 into a groove portion 46.

Embodiments—Part V

In particular, in washing machines, dishwashers and dryers, it is necessary to securely close appliance doors during operation, i.e. to generate forces (see part II) which maintain the appliance doors in closed position. As set forth above, this can be accomplished by appliances doors being moved into their closing positions or being maintained there by means of one or several memory metal actuators. In door latches in which securing of appliances doors in the closed condition is accomplished, for example, by means of spring elements, it can be necessary that significant forces must be applied by a user for closing the appliances doors which limit the comfort. In order to support a user in those cases in closing appliances doors, it is known to employ electric motors which generate forces supporting the user in closing the appliances doors. Here, powerful and large electric motors as well as mechanical means connected thereto (e.g. transmissions, gears and the like) are necessary whereby this approach is cost intensive and complex as regards construction.

Memory metal actuators which are able to generate high forces at small dimensions solve these problems. In order to support a closing process, memory metal actuators can be arranged in a door latch such that, if a bolt nab of an appliance door comes into engagement with respective components of the door latch (e.g. a gripping latch), the memory metal actuator is activated such that it at least supports the movements of components of the door latch occurring during the closing process, preferably accomplishing the same virtually without forces to be applied by the user. Here, the bolt nab and the door latch are caused into a closed condition whereby the appliance door is pulled closed. A thread to users for example in the form of clamping of fingers, can be avoided here by activating of the memory metal actuator supporting the closing process when the bolt nab comes into engagement with the door latch, i.e. the appliance door is at least “leant on”, thus, no gaps are present between the appliance door and the housing of the household appliance.

The support of closing processes of doors of household appliances can also be accomplished by means of memory metal actuators being arranged in portions in which household appliances doors are rotatably and pivotably, respectively, connected to the housing of the respective household appliances.

In FIGS. V 1a and V 1b, an embodiment of a door latch is illustrated which supports the closing process of a household appliance door. In a housing 10, a rotation latch 14, which is biased in anti-clockwise direction by means of not illustrated spring, is arranged supported rotatably about an axle 12. The rotation latch 14 cooperates with a lever 16 which can be operated by means of a memory metal actuator 18 in order to effect rotations of the rotation latch 14. During closing a household appliance door comprising bolt nab 20, an end 22 of the bolt nab is moved into engagement with a recess 22 formed in the rotation latch 14. Closing the household appliance door, the rotation latch 14 is rotated in clockwise direction wherein the rotation of the rotation latch 14 and, thus, the closing process are actively supported by means of a respectively controlled activation of the memory metal actuator 18. In this manner, the household appliance door is pulled closed by the forces generated by the memory metal actuator 18 and can be maintained in the closed condition with increased force if the memory metal actuator 18 remains activated in a continuous manner according to one of the above described ways.

For opening the household appliance door, the memory metal actuator 18 is deactivated whereby the closing forces acting on the household appliance door are released and the household appliance door can easily be opened. In case, only the closing process and the closing condition, respectively, of the household appliance door should be supported in that door latch, a one-way memory metal actuator is used as the memory metal actuator 18. Support of the opening process can, for example, be effected by a spring which provides a rotation of the rotation latch 14 in anti-clockwise direction when the memory metal actuator 18 is deactivated.

Further, it is possible to support the opening of the household appliance door by means of a one-way memory metal actuator (no illustrated) which is activated upon an deactivation of the memory metal actuator 18 and at least supports rotations of the rotation latch 14 in anti-clockwise direction. As an alternative, it is possible to use a two-way memory metal actuator as the memory metal actuator 18 which is heated above its upper threshold temperature when closing (pulling closed) the household appliance door and which is, advantageously, maintained above its upper threshold temperature for securing the household appliance door. Cooling of the two-way memory metal actuator below its lower threshold temperature effects or at least supports rotations of the rotation latch 14 in anti-clockwise direction whereby the opening of the appliance door it at least supported. The cooling of the two-way memory actuator required for that purpose can, as described at the beginning, accelerated by active measures.

In the variation of the above described embodiment illustrated in FIG. V 2a and FIG. V 2b, a connecting link guide 26 cooperating with a lever 16 is used. The function of the connecting link guide 26 is comparable to the connecting link guide described with reference to FIGS. IV 2a to IV 2c. Thus, a one-way memory metal actuator can be uses as the memory metal actuator 18 which is activated in pulse-like manner for pulling the household appliance door, i.e. for rotating the rotation latch 14 in clockwise direction. Here, the lever 16 cooperates, for example, with a not illustrated guiding pin and a guiding groove 28 formed in the connecting link guide 26 such that, subsequent to the pulse-like activation of the memory metal actuator 18, the position illustrated in FIG. V 2b is taken and maintained. In order to release the rotation latch 14 for opening the household appliance door, the one-way memory metal actuator 18 is activated once more in pulse-like manner whereby the position shown in FIG. V 2a is taken. The transition into this position can be effected by means of the not illustrated biasing spring for the rotation latch 14, by means of a compression spring (not illustrated) cooperating with the lever 16 and the like.

Embodiments—Part VI

In FIGS. VI 1a and VI 1b, a door latch for household appliance is illustrated which comprises a housing 10, a latching slider 12 and a closing hook 16 being arranged rotatably about an axle 14. On one end, the closing hook 16 includes a nose 18 and the closing hook 16 is biased to the left in the position shown in the figures by means of a not illustrated spring. The latching slider 12 cooperates with a compression spring 20. After closing a not illustrated appliance door which comprises the closing hook 16, the door latch takes the condition shown in FIG. VI 1a. Closing the appliance door, the closing hook 16 is moved through an opening 22 in the housing 10 wherein a surface 24 of the nose 18 slides along a surface 26 of the housing 10 inwards and is guided through an opening 28 formed in the latching slider 12. When the nose 18 has passed the opening 22, the closing hook 16 moves into the biased position illustrated in the figures. Here, the latching slider 12 is moved in opposite direction to the right by means of the forces generated by the compression spring 20.

Further, the door latch comprises a locking slider 30 having an opening 32 formed therein through which a one-way memory actuator 34 is guided. The memory metal actuator 34 is mounted with one end 36 to the housing 10 and cooperates, with an end 38, with a tension spring 40. In the activated condition of the memory metal actuator 34, which is not illustrated in FIG. VI 2a, the tension spring 40 maintains the memory metal actuator 34 and, as a result, the locking slider 30 in the positions shown there.

In order to latch the door latch, i.e. to ensure that the closing hook 16 cannot be moved from the position shown in FIG. VI 1a, the locking slider 30 is, as illustrated in FIG. VI 1b, guided, at least partially, through an opening 42 in the latching slider 12. Thereby, movements of the latching slider 12 are prevented.

For moving the locking slider 30 in the position shown in FIG. VI 1b, the memory metal actuator 34 is activated wherein it takes the shape illustrated there. The memory metal actuator 34 can be activated in pulse-like manner and can be maintained in heated condition, in which the memory metal actuator 34 maintains the shape shown in FIG. VI 1b, for example, as describe above, by means of a PTC element 44.

In order to unlatch the door latch, the memory metal actuator 34 is deactivated and the tension spring 40 provides for a transition of the locking sliver 30 in the position shown in FIG. II 1a. Then, the closing hook 16 can be removed through the opening 22 from the housing 10 if, during opening the not illustrated household appliance door, the closing hook 16 is rotated in clockwise direction and the latching sliver 12 is moved at the same time so far to the left that the nose 18 can be moved out of the opening 28 and through the opening 22.

As an alternative, the tension spring 42 and the memory metal actuator 44 in this embodiment can be arranged such that the tension spring generates a force acting to the left which maintains the lever 36 in the position shown in FIG. VI 1b, whereas the memory metal actuator 44, upon an activation, generates forces which rotate the lever 36 in clockwise direction. In this variation, the end 46 of the locking slider 30 rests on the upper surface 48 of the latching slider 12 when the closing hook 16 and in particular its nose 18 are outside the housing 10. If, in the above-described closing process, the latching slider 12 is moved to the right by the closing hook 16 and its nose 18, respectively, against the compression spring 20, the end 26 of the locking slider 30 engages the opening 46 of the latching slider 12 due to the force action of the tension spring 42 in an automatic manner and, thus, latches the door latch.

For unlatching, the memory metal actuator 44 is activated in order to rotate the lever 36 in clockwise direction and, thus, to move the locking slider 30 upwards and to release the latching slider 12. This embodiment provides for an automatic latching of the household appliance door without the need for an actuation of the memory metal actuator.

In the embodiments illustrated in FIG. VI 2a and FIG. VI 2b, a L-shaped locking lever 50 is used which is arranged rotatably around an axle 52. A tension spring 54, engaging on a leg of the locking lever 50, maintains the locking lever 50 in the position shown in FIG. VI 2a wherein an end 56 of the locking lever 50 does not engage an opening 58 in the latching slider 12. Accordingly, these door latch is not in a latched condition.

For latching this door latch, a memory metal actuator 60 is activated which moves the locking lever 50 in the position shown in FIG. VI 2b wherein its end 56 engages the opening 58 and, thus, locks the latching slider 12. For unlatching, the memory metal actuator 60 is deactivated and the tension spring 54 moves the locking lever 50 in the position shown in FIG. VI 2a. Thereby, the end 56 of the locking lever 50 is moved out of the opening 58 in the latching slider 12 and the same is released.

In the variation illustrated in FIGS. VI 3a and VI 3b, it is not necessary to activate the memory metal actuator 44 in a continuous manner in order to maintain the lever 36 and, thus, the locking slider 30 in the position illustrated in FIG. VI 3b and FIG. VI 1b, respectively. Here, a connecting link guide 62 cooperating with the lever 36 is used which, as described above, provides upon activation of the memory metal actuator 44 that the lever 36 and, thus, the locking slider 30 are maintained in the position necessary for latching the door latch without an activation of the memory metal actuator 44 (see FIG. VI 3b). For unlatching, the memory metal actuator 44 is activated in pulse-like manner whereby, in cooperation with the connecting link guide 62, the lever 36 is slightly rotated in clockwise direction and, then, moved into the position shown in FIG. VI 3a by the tension spring 42.

Embodiments—Part VII

The door lock 1 shown in FIG. VII 1a in an open position comprises a securing device 10 for receiving the components of the door lock 1 described in the following. The securing device 10 may be a stand, a frame or a housing, for example. Arranged in the securing device 10 so as to be pivotable about an axle 12 is a closing lever 14. In the illustrated open position, a one way memory metal actuator 16, being not activated here, is arranged between the end of the closing lever 14 opposite the axle 12 and the securing device 10. Due to its deactivated condition, the memory metal actuator 16 can be deformed by external forces. As described in the following, the allows operating the closing lever 14 and components associated thereto.

A gripping device 18 described in detail in the following is accommodated so as to rotate about an axle 20. The axle 20 is arranged between the end of the closing lever 14 contacting the memory metal actuator 16 and the end of the closing lever 14 connected to the axle 12. A torsion spring, not shown here, is connected to the gripping device 18 and exerts forces upon the gripping device 18 in order to at least support rotations of the gripping device 18 in a clockwise direction according to FIG. VII 1, as will be described below, or to exert rotary forces upon the gripping device 18 in a clockwise direction. This has the benefit that the gripping device 18 is maintained in the position shown in FIG. VII 1a and cannot be moved from this position “by its own” by external forces, such as vibrations. In a comparable manner, a torsion spring not shown can be arranged on the axle 12 and can cooperate with the closing lever 14 such that this is also maintained in the position shown in FIG. VII 1a.

The gripping device 18 comprises a gripping latch 22. The gripping latch 22 is an eccentric indentation in the circumferential line of the gripping device 18. In the open position (FIG. VII 1a), the opening of the gripping latch 22 points in a direction in which it can receive a bolt nab or closing hook 24 of an appliance door, not shown, which is to be closed by means of the door lock 1. In order to close the appliance door and therefore the door lock 1, the bolt nab 24 is guided (for example by an opening, not indicated, appropriately arranged in the securing device 10) into the receiving region of the gripping latch 27, where it presses against a contact surface 26 and rotates the gripping device 18 in an anti-clockwise direction according to FIG. VII 1a. As a result of this rotation, an abutment position 28 of the gripping device 18 contacts a stop 30 formed on the free hand of the closing lever 14. Thereby, the closing lever 14, also in an anti-clockwise direction, is cooperatively moved until the closing lever 14 contacts a not shown stop being formed on the housing 10 which limits movements of the closing lever 14. A termination of the rotation of the closing lever 14 in an anti-clockwise direction can also accomplished by the appliance door comprising the bolt nab 24 abutting on respective surfaces of the housing. The condition of the door lock 1 referred to as closed position is shown in FIG. VII 1b.

In order to maintain the door lock 1 in the closed position shown in FIG. VII 1b, the memory metal actuator 16 is actuated in order to apply forces which maintain the closing lever 14 and the gripping device 18 in its positions shown in FIG. VII 1b. In particular, it is contemplated that the memory metal actuator 16 applies forces being large enough to securely maintain the bolt nab 24 in the gripping latch 22 for operation of the household appliance.

After operation of the household appliance, the activation of the memory metal actuator 16 is terminated. When its temperature falls below a corresponding threshold temperature, above which the shape variation occurs being required for generation of the said forces, the memory metal actuator can be deformed in any way by external forces. This allows to bring the gripping device 18 and the closing lever 14 in the positions shown in FIG. XII 1a, for example, by opening the appliance door comprising the closing lever 14. As described above, if required, the cooling of the memory metal actuator 16 necessary for that purpose can be supported by further measures.

In a not shown embodiment, in addition to the memory metal actuator 16 used for securing the closed position (FIG. VII 1b), a further one-way memory metal actuator is used which supports at least the transition from the closed position (FIG. VII 1b) into the open position (FIG. II 1a). For that purpose, this further memory metal actuator is activated in order to generate forces which cause the gripping device 18 and the closing lever 14 in the positions shown in FIG. VII 1a. In dependence of the design of this memory metal actuator, in this manner, an actual opening of the appliance door comprising the closing lever 14 can be effected.

Embodiments—Part VIII

FIGS. VIII 1 to VIII 4 schematically illustrate a sectional view through a latching device for the door of, for example, a washing machine. The shown latching device serves to latch a door hook in a closing position of the door. In FIGS. VIII 1 to VIII 4, the door and the door hook are not shown. These are shown in FIG. VIII 5 and VIII 6 and cooperate according to FIGS. VIII 1 to VIII 4 with the latching device in a manner described below by reference to FIG. VIII 5 and VIII 6.

In the illustrated embodiment, the latching device according to FIGS. VIII 1 to VII 4 is arranged in a housing 10 of the washing machine.

The latching device comprises a latching body 12 which is linearly displaceable to the left and to the right, respectively, in FIGS. VIII 1 to VIII 4 (see arrow 30).

A locking bolt 14 serves to latch the latching body 12 in a closing position for specific operation positions wherein the latching body, due to its arrest, also maintains the door closed which is described below by reference to FIGS. VIII 5 and VIII 6.

In the embodiment according to FIGS. VIII 1 to VIII 4, a bi-stable element 16 is formed as swivable lever and serves to move the locking bolt 14 in different operation positions.

In the latching body 12, a window 18 is formed which comprises bars 20 and 22, respectively, on, referring to FIG. VIII 1 to VIII 4, left and right sides which can also be seen in FIGS. VIII and VIII 6.

A spring 24 effects a bi-stable support of the latching body 12. For that purpose, the spiral spring 24 is securely connected with both ends with the latching body 12 and is concentrically guided by two jaws 26, 28 which are rigidly connected with the housing.

The possibility to linearly displace the latching body 12 is obtained by guiding the same between two guides 36, 38 such that it is displaceable in direction of the double arrow 30 to the left and to the right, respectively.

On the right end of the latching body 12, there is provided a coupling part 34 in form of a loop bent out of the drawing plane being integrally connected to the latching body 12. The coupling part 34 effects a force coupling between the latching body 12 and a first electrical switch 40. The electrical switch 40 comprises two arms 42, 44 which comprise on their ends contact pieces which can be brought in contact with each other. The arm 44 of the switch 40 illustrated on the right side in FIG. VIII 1 is prevented from a movement to the left by a pin 45. The arms 42, 44 are resiliently biased such that they move towards each other without external force exposure and close the contact (see FIGS. VIII 2 and VIII 3). Also, the arm 44 can be formed rigidly such that only the arm 42 is resiliently biased and moveable.

The bi-stable element 16 being formed as lever is rotatably about a rotation axle 46. Two one-way memory metal actuators 50 and 52, which can be activated independently with respect to each, other engage a level arm end of the bi-stable element 16 such that, by means of an activation of the memory metal actuator 50 or 52, a movement of the bi-stable element can be initiated in a desired direction. Depending in which direction the bi-stable element 16 is to be moved, either memory metal actuator 50 or memory metal actuator 52 is actuated, i.e. heated such that the respective threshold temperature is exceeded above which the memory metal components of the actuators 50 and 52, respectively, take the respective predefined shape and, thus, generate the forces required for operation of the bi-stable element 16. For energy supply, the memory metal actuators 50 and 52 are provided with flexible supplies 50a and 50b.

In a not illustrated embodiment, in place of the one-way memory metal actuators 50 and 52, a single two-way memory metal actuator is used. Here, the operation of the bi-stable element 16 is obtained by heating the memory metal components above their upper threshold temperature or by cooling below the lower threshold temperature. For cooling the two-way memory metal actuator, the measures mentioned at the beginning can be taken in case the time up to the operation of the bi-stable element 16 associated with the cooling below a threshold temperature is to be reduced, thus, in case, one does not intend to wait until the two-way memory metal actuator cools below the lower threshold temperature without additional cooling. In order to avoid an undesired cooling, one or both memory metal actuators 50 and 52 can be maintained heated in the above described ways.

In a further not illustrated embodiment, in contrast to the arrangement illustrated in FIG. VIII 1, the one-way memory metal actuators are arranged such that they engage on opposite sides of the lever arm end of the bi-stable element 16.

The bi-stable element 16 is supported by means of a spring 54 such that it is biased in its two swivel end positions. For that purpose, the spiral spring 54, which is securely connected with its both ends (as illustrated) with the bi-stable element 16, is guided between two jaws 56, 58 which are securely connected with the housing 10. FIGS. VIII 1 and VIII 2 show two stable end positions of the bi-stable element 16. In the below further described open position of the latching device shown in FIG. VIII 1, the spring 54 pushes the bi-stable element 16 in clockwise direction. In the closing position of the latching device according to FIG. VIII 2, the spring 54 pushes the lever shaped bi-stable element 16 in anti-clockwise direction. In a transition of the operation position of the bi-stable element 16 according to FIG. VIII 1 in the position according to FIG. VIII 2 (and vice versa), the spring 54 is squeezed together against its spread force such that it reaches, at a specific transition location between the two positions, a snap point with a maximum of potential energy which is partially transformed in kinetic energy upon further swiveling of the bi-stable element 16 about its rotation axle 46 and which causes the bi-stable element 16 in the illustrated end positions to which it is referred in detail further below.

The bi-stable element 16 includes an integrally formed coupling part 60. In case, the bi-stable element 16 is positioned in front of the locking lever 14 according to FIG. VIII 1, then, the coupling part 16 is formed as loop being outwardly bent from the drawing plane to the back. The coupling part 60 engages a window 66 in locking lever 14.

The locking lever 14 is guided between two guides 62, 64 in a linear moveable manner, thus, can be moved downwards and upwards, respectively, in FIGS. VIII 1 to VIII 4, i.e. perpendicular to the moving direction of the latching body 12. The coupling part 60 of the bi-stable element 16 can be moved upwards and downwards, respectively, in window 66 in relation to locking lever 14 wherein it contacts the upper and lower, respectively, edge of the window 66 and, depending of the operation condition, moves the locking lever 14 in different positions.

The locking lever 14 includes an edge 31 which abuts on an edge 32 of the latching body 12 in the closing position of the latching body 12 according to FIG. VIII 2. In a further possible operation position (FIG. VIII 4), the lower edge of the locking lever 14 abuts on an upper edge 68 of the latching body 12.

During its movements, the locking lever 14 drives a second switch 40 which, comparable to the above described first switch 40, comprises two arms 72, 74 having contact elements. A stop 46 limits the moveability of the lower arm 74 in upward direction. In case, no external force is acting on the arms 72, 74 of the second switch 70, then, the contact is closed (see FIG. VIII 2). The arm 74 can also be rigidly formed such that only the arm 72 is resiliently biased and moveable.

An emergency unlatching lever 80 can be swiveled about a rotation axle 78 and serves, in particular in case of a power failure, to move the locking lever 14 upwards in an open position. Here, the emergency unlatching lever 80 is swiveled in anti-clockwise direction by means of a lever.

FIGS. VIII 5 and VIII 6 show a cross-sectional view in the portion of the window 18 of the latching body 12 in a plane perpendicular to the drawing plane according to FIGS. VIII 1 to VIII 4. In a lower part 10b of the housing 10, an opening 82 is formed which, in the open condition of the latching device according to FIG. VIII 1, is, at least approximately, aligned with the window 18 in latching body 12. On the opposite side, the housing is covered by a housing upper part 10a. Also in FIG. VIII 5, the bars 20, 22 on the edges of the window 18 are illustrated (see also FIG. VIII 1).

In its lower position, FIG. VIII 5 schematically shows a door 86 having a door hook 84 which can be slided in the window 18 through the opening 82. This closed position of the door is illustrated in FIG. VIII 6. The door hook 84 penetrating the window 18 upon closing the door is biased in clockwise direction in relation to a rotation axle 88 by means of a spring 90 such that, upon penetration the window 18 and a displacement of the latching body 12 (in the figures to the right side), engages behind a nose 84 on the housing lower part 10b. By means of a handle 92, the door hook 84 is to be operated by a user wherein it is rotated in anti-clockwise direction and pushes the locking body to the left in case the same is released.

As shown by FIG. VIII 6, a latching of the latching body 12 in the closed position at the right side effects that the door hook 84 cannot exit from the opening 82 of the housing, i.e. the door is latched in the closed condition.

The function of the above described device is at follows:

FIG. VIII 1 shows an open position of the latching device (corresponding to FIG. VIII 5). Upon closing the door, the door hook 84 dives through the window 18 of the latching body 12 and pushes the latching body 12, in the figures, to the right wherein the first switch 40 is closed in order to inform the electronic control of the machine of the closed condition of the latching body 12 by means of a respective electrical signal.

Upon closing the door, the door hook engages behind the nose 84 of the housing (FIG. VIII 6) and the door is closed. As long as the latching body 12 is not blocked (latched) in its end position at the right side, the user can open the door by means of the door handle 92. Here, the washing machine is not required to be connected to an electrical voltage. Thus, the washing machine can be also opened without effort in a showroom.

The user of the machine can start the same, for example, by means of a start button. During the program course of the washing process, there are different conditions in which it is indispensable due to security reasons, that the door 86 cannot be opened. As soon as such conditions occur during the program course of the washing machine, the electronic control actuates the memory metal actuator 50 such that the latching body 12 and, thus, also the door are latched. Due to the connection of the memory metal actuator 50 with the bi-stable element 16, in this embodiment, the memory metal actuator 50 essentially influences the dynamic of the bi-stable element 16. Here, the bi-stable element 16 overcome the above described snap point of the spring 54. Having overcome the snap point (that is the point of maximal potential energy in the spring 54), the spring 54 pushes the bi-stable element 16 further in anti-clockwise direction into the position according to FIG. VIII 2. The coupling part 60 of the bi-stable element 16 abuts, after a certain period of time after having passed the snap point, the lower edge of the window 66 in locking lever 14 wherein the locking lever 14 with its edge 31 is pushed in front of the edge 32 of the latching body 12. This condition is shown in FIG. VIII 2.

For this transition from the open position according to FIG. VIII 1 into the latching position according to FIG. VIII 2, the second switch 70 is closed. The locking lever 14 is matingly connected (not shown) to the arm 72 of the switch 70 such that a forced coupling is existing between the locking lever and the switch. Due to the closing of the second switch 70, the electronic control of the machine obtains the signal “door latched”.

In case, only in given periods of time during the program course of the washing machine or also at the end of the program, the latching body 12 is to be unlatched, the memory metal actuator 52 is actuated such that the bi-stable element 16 is rotated slightly in clockwise direction about its rotation axle 46. Then, the bi-stable element 16 snaps in the open position according to FIG. VIII 1 having overcome the above described snap point. After a certain period of time after having passed the snap point, the coupling part 60 of the bi-stable element 16 abuts the upper edge of the window 66 in locking lever 14. Thus, the coupling part 60 has, upon contacting the upper edge of the window 66, gained some kinetic energy which was previously stored as potential energy in the spring 54 (in the snap point). The memory metal actuator 52 influences due to its coupling to the bi-stable element 16 its moving dynamics. The memory metal actuator 52 is coupled to the bi-stable element 16 such and the travels are adapted such that the kinetic energy of the coupling part is maximal upon contacting the stop. As the coupling part 60 contacts the upper edge in window 66, the locking lever 14 is pushed upwards into the unlatched position according to FIG. VIII 1 wherein the second switch 70 is opened due to the given forced coupling. Only in case the contact 70 is open, the locking lever 14 also is in its upper end position corresponding to an unlatched condition (FIG. VIII 19). Then, the door 86 can be opened.

The coupling part 34 on latching body 12 ensures, due to the forced coupling, that the first switch 40 is opened when the door is opened and the latching body 12 is moved in the open position according to FIG. VIII 1 due to a displacement to the left beyond the snap point of the spring 24. Thus, the spring 24 cooperates with the housing jaws 26, 28 in a manner as the spring 54 of the bi-stable element 16 with the housing jaws 56, 58.

FIG. VIII 3 illustrates the special condition already addressed above wherein a user powerfully pulls the door handle 92 whereas the memory metal actuator 52 tries to move the bi-stable element 16 and, thus, also the locking lever 14 in the unlatched position. In such a condition, the friction between the locking lever 14 and the edge 32 of the latching body 12 can be large to an extent that that the locking lever 14 cannot move in the open position (upwards).

The frictional force (essentially adhesive friction) between the edge 32 of the latching body 12 and the abutting edge of the locking lever 14 (see FIG. VIII 3) is generated by the user of the washing machine when powerfully pulling on handle 92 and swiveling the door hook 84 in anti-clockwise direction wherein the same presses against bar 20 (FIG. VIII 6) of the latching body 12.

The described latching device solves this problem in that the bi-stable element 16 has already overcome the snap point of the spring 54 in this condition, thus, is strongly biased in direction towards the open position (in clockwise direction). Thus, as soon as the user releases the door handle 92, the bi-stable element 16 completes the opening movement and the coupling part 60 abuts on the upper edge of the window 66 and moves the locking lever 14 in the open position in which it releases the latching body 12 for a movement in the open position (to the left in the figures). The spring 24 and the spring 90 of the door hook 84 push the latching body 12 in the open position again. Then, the spring 54 which already biases the locking lever 14 in the open position, then, finally pushes the locking lever 14 in the open position according to FIG. VIII 1 wherein a second contact 70 is also opened.

Thus, the described latching device “stores” the opening instruction (given in form of the actuation of the memory metal actuator 52) comparable to a “mechanical instruction memory”. Even if the instruction is not present any more in electric form, the system mechanically “knows” due to the described spring tensions and snap points that is has to complete the opening movement. This makes it possible that the memory metal actuator 52 has to be actuated just for a short period of time.

Further, the described arrangement results that the lever-like bistable element 16 is not subjected friction in operational condition (even in case of a wrong operation). Rather, such friction only occurs on locking lever 14.

Further, the described device has the benefit that, due to the described snap point and the thusly enabled transformation of potential spring energy in kinetic energy of the coupling part 60, relatively strong pulses are acting on the locking lever upon displacement and, thus, adhesive friction, sticking and the like can be overcome.

The above described “mechanical instruction memory” can also be used in advantageous manner for closing the door. If, for example, the user of the washing machine pushes the start button (of the program course) as the door is open and the program sequential logic system drives the memory metal actuator 50 used for latching, the bi-stable element 16 snaps in its latching position and pushes the locking lever 14 against the latching body 12. This is shown in FIG. VIII 4. If the user closes the door hereafter, the latching body 12 is pushed to the right and the contact 40 is closed. At the same time, the locking lever 14 slides in the latching position (FIG. VIII 2) via biasing by means of the bi-stable element 16. Thus, the washing program can start without the need that the user has to operate the start button again.

Normally, the door can always be opened by means of the door handle 92 even in a voltage less condition. However, in case the electric supply fails in the latched condition, the lock must be unlatched by means of the emergency unlatching lever 80. Here, by means of rotating the emergency unlatching lever about its rotation axle 78, the locking lever 14 is moved in the open position. Thereby it is insured that the emergency unlatching lever 80 can also be operated if one or both memory metal actuators 50 and 52 are damaged.

FIG. VIII 7 describes a further embodiment of a device for latching the door of a household appliance wherein, in contrast to the above described embodiment, the bi-stable element is modified. In the figures, components corresponding with respect to each other or having comparable functions are indicated by like reference numerals, if applicable, differentiated by adding a letter.

FIG. VIII 7 shows the door latch in open condition. The locking lever 14 and the latching body 12 essentially correspond to the embodiment according to FIGS. VIII 1 to VIII 6. In modification of the embodiment according to FIGS. VIII 1 to VIII 6, the bi-stable element 16a in the embodiment according to FIG. VIII 7 is formed as a slider, thus, translationally movable downwards and upwards in FIG. VIII 7. Corresponding to the previously described embodiment, the bi-stable element 16a is coupled to the memory metal actuators 50 and 52. By means of a spring 54a which is guided between jaws 56a, 58a, the bi-stable element 16a is biased in two end positions in a manner analogous to the above described bi-stable support of the element 16 by means of the spring 54. Also, the above explained snap-point is analogously given for the bi-stable element 16a.

In the embodiment according to FIG. VIII 7, the bi-stable element 16a is coupled to the locking lever 14 via an elongated hole 60a in the bi-stable element 16a and a pin 14a being securely connected to the locking lever 14 which extends in the elongated hole 60a. If the bi-stable element 16a is pulled downwards in FIG. VIII 7 upon operation of the memory metal actuator 50, the pin 14a contacts the upper end of the elongated hole 60a and the locking lever 14 is moved in the closing position in which it abuts with the edge 31 on the stop edge 32 of the latching body 12 (wherein the same is previously pushed to the right upon closing the door analogously to the above described embodiment) and, thus, the door is latched.

FIGS. VIII 8 and VIII 9 show a further embodiment which, in comparison to the two above described embodiments, is simplified in that regard that the bi-stable element 16b directly effects the latching of the door hook 84a. In the embodiment according to FIGS. VIII 8 and VIII 9, the bi-stable element 16b directly cooperates with a latching body 12a which directly latches the door hook 84a in the closing position by means of a bar 22a in the latching condition of the door.

The bi-stable element 16b also formed as slider in this embodiment is coupled to memory metal actuators 50 and 52 by means of a plunger 48. Analogous to the embodiment according to FIG. VIII 7, the bi-stable element 16b is biased in two end positions by means of a spring 54b which is guided between jaws. FIG. VIII 8 shows the latch in closed position in which the bi-stable element 16b is pushed to the farest left in the figure. The movement of the bi-stable element 16b to the left and to the right, respectively, is limited by the cooperation of elongated holes 96, 98 with fixed pins 104, 106. In closed position according to FIG. VIII 8, the bi-stable element 16b has moved the latching body 12a in its end position on the left side which is also illustrated in FIG. VIII 9. In this end position, the latching body 12a engages, with its front edge 22a that corresponds to the bar 22 of the above described embodiments as regards its function, a recess in the door hook 84a in order to latch the hook. In this position, an electric contact, formed by a rigid arm 44a and a resiliently biased arm 42a, is closed.

In the closing position, the door hook 84a engages, according to FIG. VIII 9, between two resilient spring arms 100, 102 which can be spread with respect from each other upon closing and opening, respectively, of the door.

For opening the door, the memory metal actuator 52 pulls the bi-stable element 16b to the right in FIG. VIII 8 wherein the spring 54b, analogous to the above embodiments, overcomes a snap point and, then, pushes the bi-stable element 16b to the right. Here, a stop 108 of the bi-stable element 16b hits a stop 110 of the latching body 12a such that the latching body moves from the closing position (see FIG. VIII 9) to the right in the figures and releases the door hook 84a for opening.

Embodiments—Part IX

FIG. IX 1 shows a device for locking a door of a domestic appliance. This device is intended for use in a washing machine. The essential components of the device are a housing 10, a locking body 12, an opener 14 and a door hook 16.

The door hook 16 is attached to the washing-machine door (not shown) and can be guided through an opening 18 in the housing 10 to the locking body 12. The door hook 16 may be either a moveable door hook or a stationary door hook.

The locking body 12 bears against a support bearing 20 on the housing 10 and is preloaded by a first spring 22 into the direction of movement of the door hook 30 when closing and transversely with respect to this direction of movement. The locking body 12 in this case bears against a first stop 24 and a second stop 26, which are both connected to the housing 10, so that the locking body 12 adopts an at-rest position.

The opener 14 is used to unlock the device and is actuated by means of a memory metal actuator 28. The opener 14 is preloaded by a second spring 30, so that the opener 14 is pushed to the left, with respect to FIG. IX 1, and bears, by way of a first shoulder 32, against an edge 34 of the locking body 12.

Furthermore, a switch 36 with a switching plunger 38 is attached to the housing 10, which switching plunger is moved into a position which opens the switch 36 by the locking body 12 which is preloaded in its at-rest position. Due to the open position of the switch, the washing machine itself cannot be operated. Such operation is also impermissible for safety reasons, since the door and therefore the door is hook 16 are not locked.

FIG. IX 2 shows the device in a closed position. The door hook 16 has been guided through the opening 18 to the locking body 12 and, in the process, has moved the locking body 12 to the right, with respect to FIG. IX 1, so that a locking edge 46 of the locking body 12 comes to rest behind a projection 40 of the door hook 16. Due to the elastic seal which is arranged in the door and is not shown, a tensile stress acts on the door hook 16, pulling the projection 40 of the door hook 16 onto the locking body 12, in the opening direction of the door. This tensile stress is greater than the spring preloading from the first spring 22, which is diagrammatically depicted as a dashed line in FIG. IX 2. Therefore, the locking body 12 is moved towards the opener 14 by the door hook 16 and comes to bear against a second shoulder 42 on the opener 14.

Thus, in the closed position which has been adopted, the locking body 12 bears against the support bearing 20, against the first stop 24 and against the second shoulder 42 on the opener 14. Its right-hand end part 44 has moved downwards, with respect to FIG. IX 2, and in the process has released the switching plunger 38 of the switch 40. Thus the switch 36 is closed, allowing the washing machine to be actuated.

The edge 34 of the locking body 12 is further than the locking edge 46 from the support bearing 20. Due to the leverage principle, a lower perpendicular force component (i.e. a downwards component as seen in FIG. IX 2) acts on the second shoulder 42 of the opener 14 than the force component which the door hook 16 on the locking edge 46 exerts on the locking body 12. Therefore, the frictional force which has to be overcome on the second shoulder 42 is also lower than on the projection 40 of the door hook 16.

FIG. IX 3 shows the device in the relaxed position. To adopt this relaxed position, the locking body 12 is moved to the right, with respect to FIG. IX 2, by means of the opener 14. This is effected by means of the memory metal actuator 28. The memory metal actuator 28 works in the opposite direction to the second spring 30, and moves the opener 14.

When the opener 14 is being displaced, the locking body 12 is held in its left-hand position, with respect to FIG. IX 3, owing to the first spring 22 and the relatively high frictional force in the area of the projection 40 on the door hook 16. The second shoulder 42 of the opener 14 therefore moves to the right, in relation to the edge 34 of the locking body 12, and the edge 34 slides over the second shoulder 42. Since the elastic seal exerts a tensile stress on the door hook 16, the door hook 16, via the projection 40, pulls the locking body 12 into the relaxed position illustrated in FIG. IX 3. In the process, the locking edge 46 of the locking body 12 has moved relative to the housing 10, in the opening direction of the door hook 16, and has therefore relieved the pressure on the seal (not shown). The switch 36 is likewise not activated in the relaxed position, since the door cannot yet be opened.

FIG. IX 4 shows an open position of the device. In order to transfer the locking body 12 from the relaxed position into this position, the memory metal actuator 28 moves the opener 14 further to the right, with respect to FIG. IX 4. This is effected by a fourth stop 58 of the opener 14, after an empty travel, coming into contact behind a second edge 50 of the locking body 12 and moving the locking body 12 along with it when the opener 14 moves. During the empty travel, the opener 14 gathers kinetic energy, so that more energy is available to move the locking body than without an empty travel. The locking body 12 moves away from the first stop 24, so that its locking edge 46 releases the projection 40 of the door hook 16.

FIG. IX 4 shows precisely the position in which the door hook 16 is released. In this position, the seal is initially likewise less strongly compressed than in the closed position. Since the door hook 16 has been released, the pressure on the seal can then be relieved further, with the effect that the door hook 16 moves out of the opening 18 and the door opens.

During the movement of the locking body 12 as far as the open position, the switching plunger 40 of the switch 38 is not actuated. However, after the locking edge 46 has released the door hook 16, the locking body 12 is moved upwards, with respect to FIG. IX 4, by the first spring 22, so that its right-hand end part 44 actuates the switching plunger 38. The switch 36 is thus opened and detects that the door has been opened.

FIG. IX 5 shows the device in a first knee test position 1. In such a knee test 1, the door of the washing machine is prevented from opening from the outside. This may, for example, result from the knee of a user bearing against the door. The memory metal actuator 28 seeks to unlock the door and has therefore moved the opener 14 to the right. In the process, the locking edge 46 of the locking body 12 has been moved to the right, past the locking edge 46 of the door hook 16, and the door hook 16 has for the time being been released. However, the pressure on the door does not allow the pressure on the seal to be relieved. The door does not open and the door hook 16 remains in the opening 18. The locking body 12 is preloaded upwards by the first spring 22. When the door hook is released, the locking body is pulled upwards and bears against the support bearing 20. It actuates the switching plunger 38, with the result that the switch 36 is opened and the supply of current to the memory metal actuator 28 is interrupted.

In the first knee test position 1, the projection 40 of the door hook 16 bears against the locking edge 46 of the locking body 12. The locking body 12 adopts a stable position. As soon as the door of the washing machine is no longer subjected to manual pressure from the outside, the door hook 16 moves out of the opening 18, since the pressure on the elastic seal of the door is relieved. The locking body 12 then adopts its at-rest position due to the preloading of the first spring 22.

FIG. IX 6 shows the device in a second knee test position 2. In such a position, the door hook 16 has been pushed into the opening 18 by manual pressure on the door sufficiently far for the locking body 12 to again be able to adopt its at-rest position without being subjected to tensile load from the door hook 16. Therefore, the projection 40 of the door hook 16 does not bear against the locking body 12. The overall position of the device corresponds to the at-rest position illustrated in FIG. IX 1, except for the fact that the door hook 16 has been pushed into the opening 18.

In this second knee test position 2, the right-hand end part 44 of the locking body 12 again actuates the switching plunger 38 of the switch 36. The switch 36 interrupts any actuation of the memory metal actuator 28, so that the door cannot be unlocked. The switch 36 is only closed again when the user ends the manual pressure on the door, so that the device moves into the closed position illustrated in FIG. IX 2. From this position, the door can be unlocked again by means of the memory metal actuator 28 and then opened.

Embodiments—Part X

At first, FIG. X 1 shows a cross-sectional view of a door latching mechanism with the door being open and the door latching mechanism being unlocked.

With the door in the open position, a door hook 10 is outside the housing 12 of the latching mechanism which is arranged in the front wall of a washing machine.

The door hook 10 is supported in a pivot point 14 and is biased by a spring 16 in FIG. X 1 to the right. The housing 12 is provided with an opening 18 into which the door hook 10 plunges upon closing. In addition, a main slide 20 with a stop part 22 is provided in the housing, which is biased by a spring 24 in such a manner that the stop part 22 abuts against a stop 26 in the housing. The main slide 20 has an opening 28 into which the door hook 10 also plunges upon closing and which is congruent with the opening 18 in the housing. The main slide also comprises a locking window 30 into which a bar element in the form of a blocking slide 32 plunges for locking which, however, in the position shown in FIG. X 1 is located laterally above the locking window 30.

A locking and unlocking mechanism comprises two-way memory metal actuator 34 which in FIG. X 1 is in position C and which exerts pressure via a compression spring 46 onto an intermediate member in the form of a switching spring 40. The switching spring 40 has a fixed end and a movable end. In areas of the movable end of the switching spring 40 said spring is connected with the blocking slide 32 in such a manner that a free arm of the switching spring 40 extends off the blocking slide 32 towards the fixed end of the switching spring 40. The free end of the switching spring 40 serves as an extension 40A of the blocking slide 32. By acting on the extension 40A the blocking slide 32 can perform a swivel motion about the fixed end of the switching spring 40.

The switching spring 40 is a bifurcated leaf spring, with the memory metal actuator 34 deforming upon heating above its upper threshold temperature and moving through the fork with one free end, while the other end of the memory metal actuator 34 is secured in the housing.

In order to prevent the switching spring 40 and the blocking slide 32 from being urged too far upwards, a stop 42 is provided for limiting their movement.

In the position shown in FIG. X 1 the memory metal actuator 34 has a temperature below its lower threshold temperature.

Furthermore, a two-way memory metal actuator 46 is provided as part of the door latching mechanism. In the position shown in FIG. X 1 the temperature of the memory metal actuator 46 is below its lower threshold temperature.

Upon closing the door, the door hook 10 plunges through the openings 18 and 28 into the housing 12 and the main slide 20, with the spring 16 being stronger than the spring 24 and thus urging the door hook 10 together with the main slide to the right in the figures so that subsequently, the locking window 30 is located immediately below the blocking slide 32. The door is now closed, but not locked, i.e. it can be opened again.

For locking the door, the memory metal actuator 34 is energized, wherein it bends the fork of the switching spring 40 upwards into position D shown in FIG. X 2 and presses the switching spring 40 with the blocking slide 32 via the compression spring 36 downwards in the figure, with the blocking slide plunging into the locking window 30 in the main slide 20. Thereby the switching spring 40 abuts against the NO contact 50.

In the position shown in FIG. X 2 the door is now closed, the stop part 22 of the main slide 20 blocks a movement of the hook out of the door latching mechanism.

If the current supply to the memory metal actuator 34 were interrupted now, the compression spring 36 and the switching spring 40 as well as the blocking slide 32 would return into the position shown in FIG. X 1 after cooling down of the memory metal actuator 34.

Because a user has to wait a long time until the door is unlocked although, for example, the drum of the washing machine is already at a standstill, the memory metal actuator 46 is activated. As shown in FIG. X 3, memory metal actuator 46 then moves the extension 40A and thus the blocking slide 32 upwards in the figure, regardless of the fact that it urges the memory metal actuator 34 together with the compression spring 36 downwards in the figure, i.e. the memory metal actuator 46 exerts a higher force on the other side of the switching spring 40 than the memory metal actuator 34 with the compression spring 36 on the one side. The door is now unlocked; by a rotation of the door hook in the bearing 14 the main slide 40 is urged to the left in the figure, and the door hook 10 can be pulled out of the openings 28 and 18, the door is opened again.

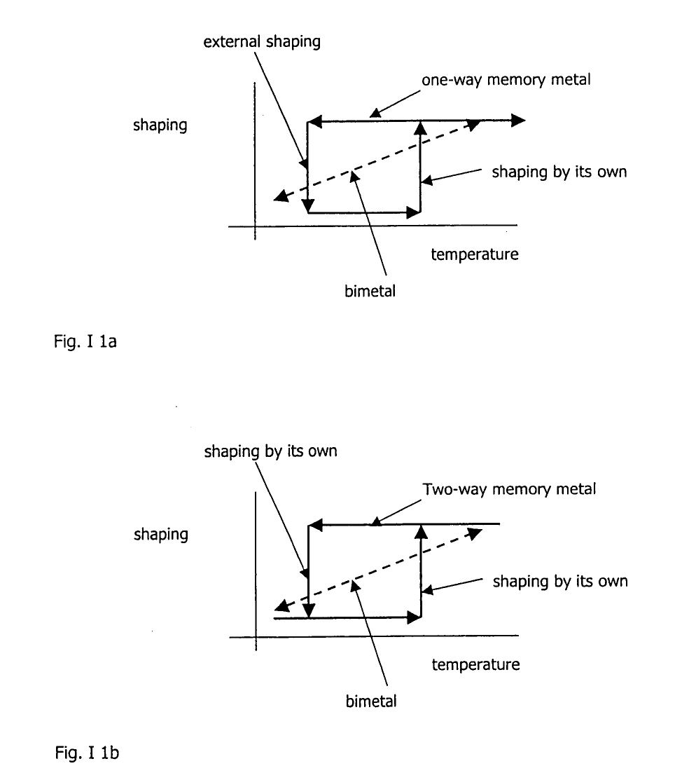

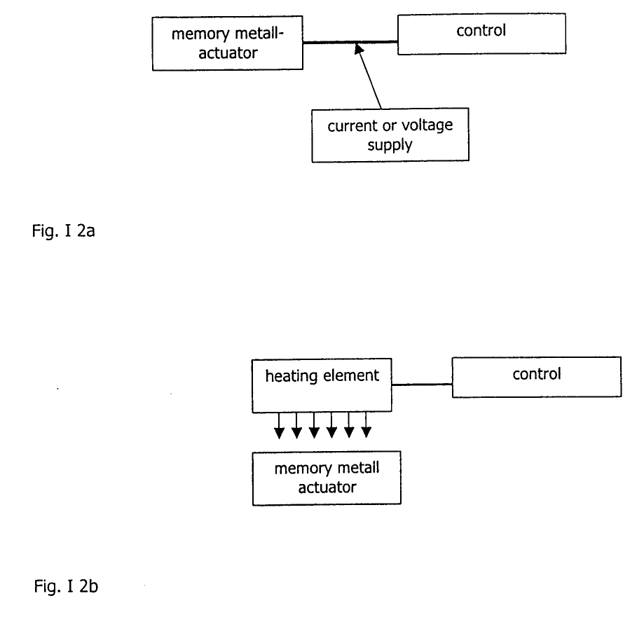

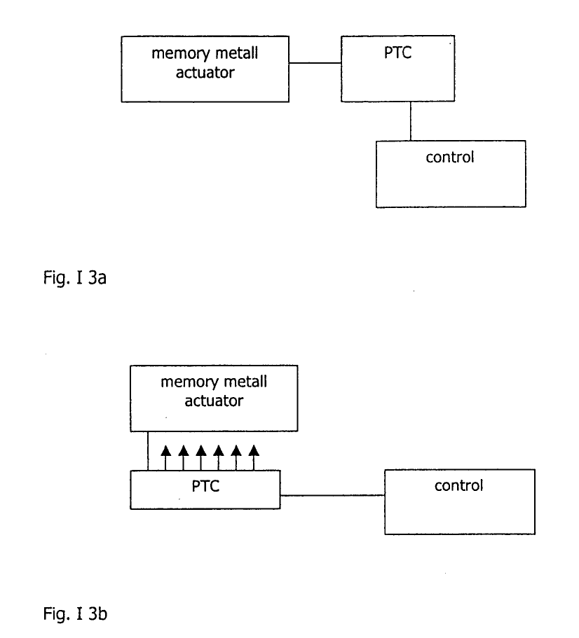

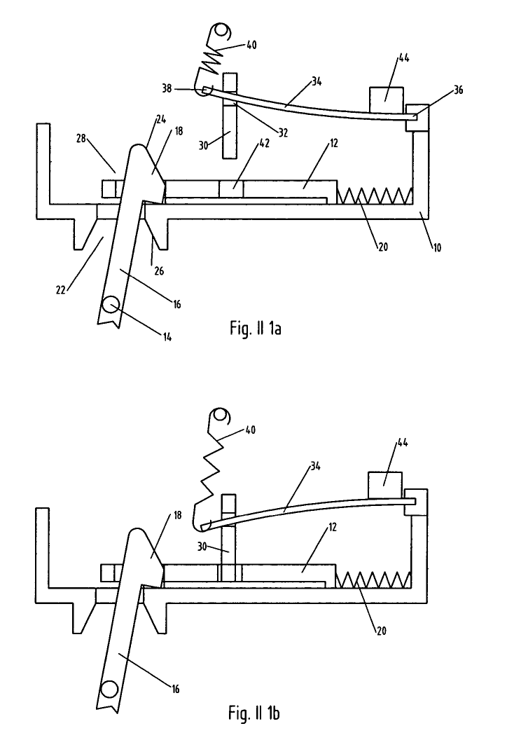

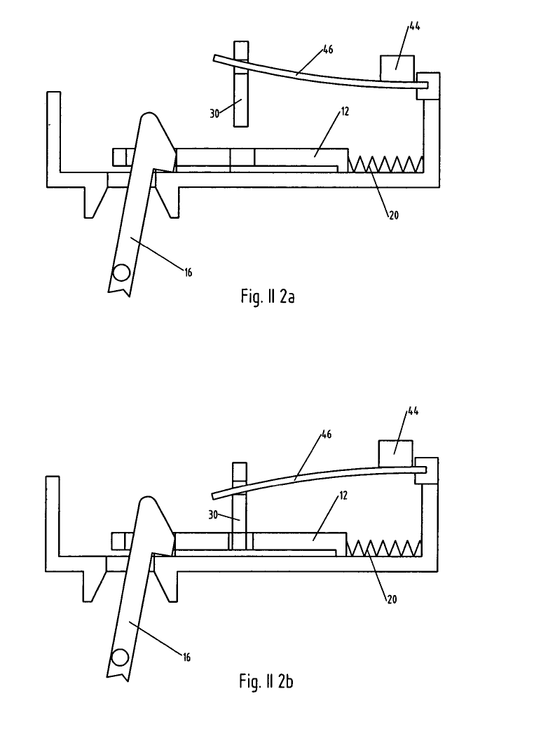

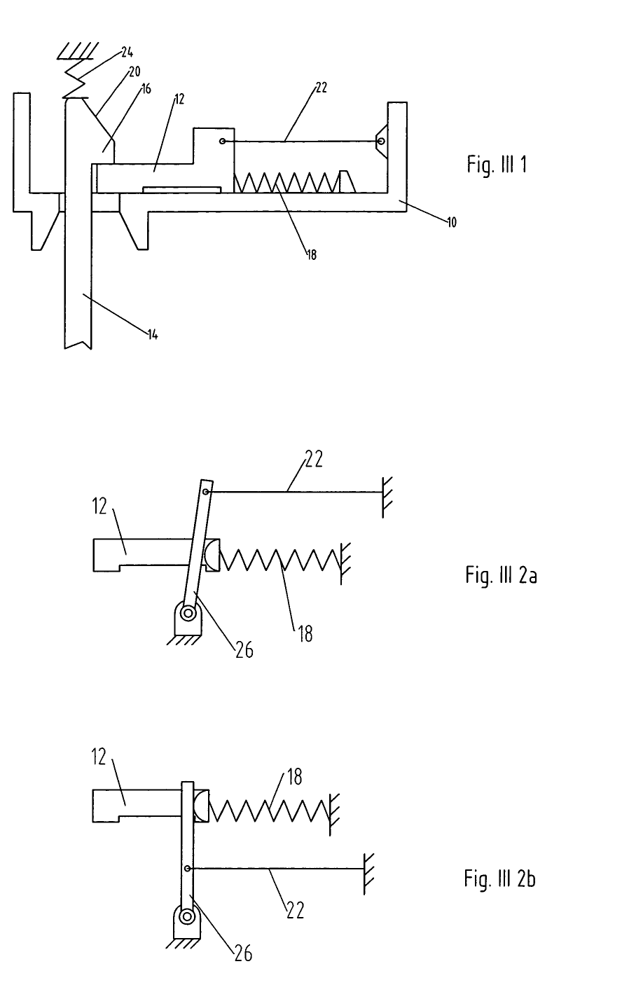

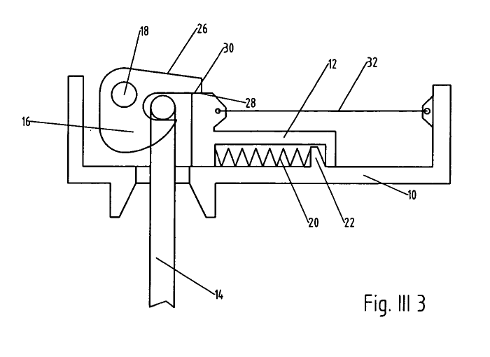

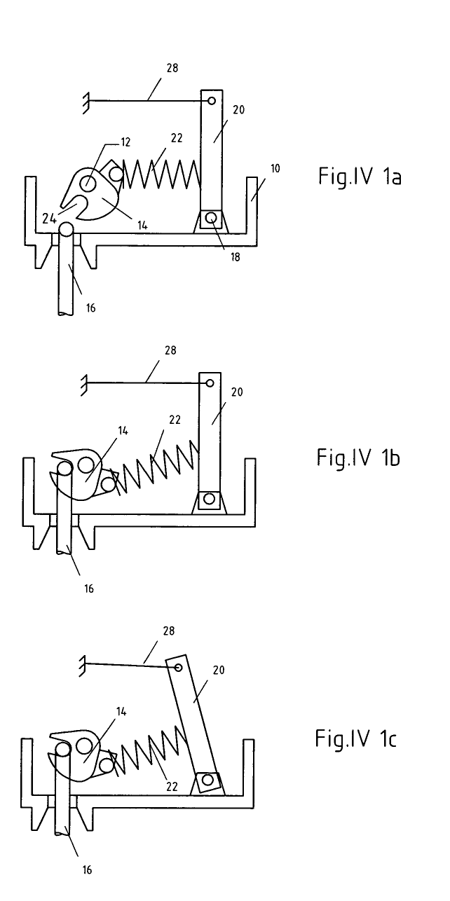

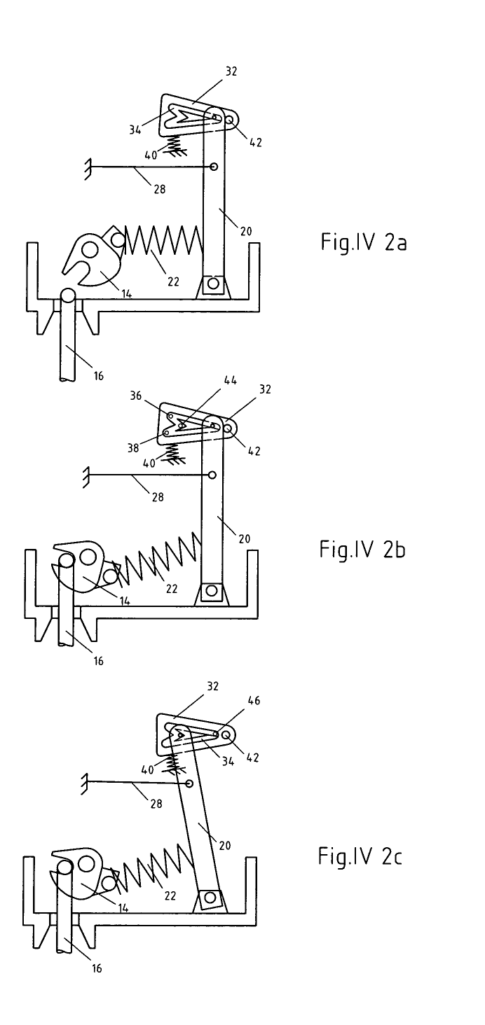

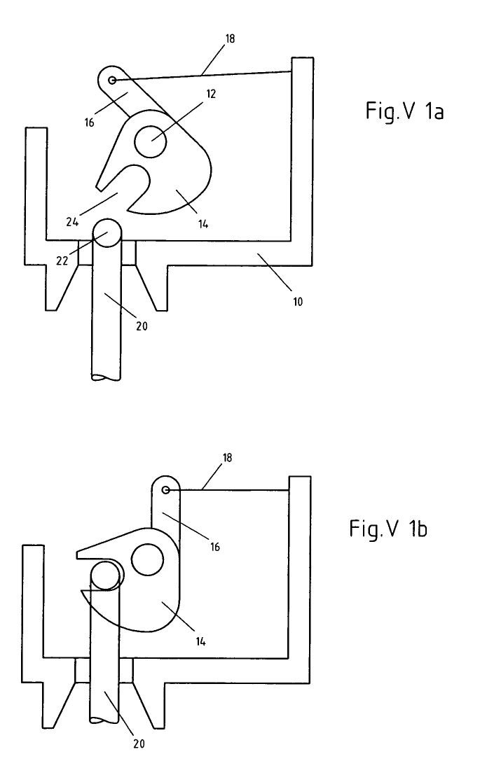

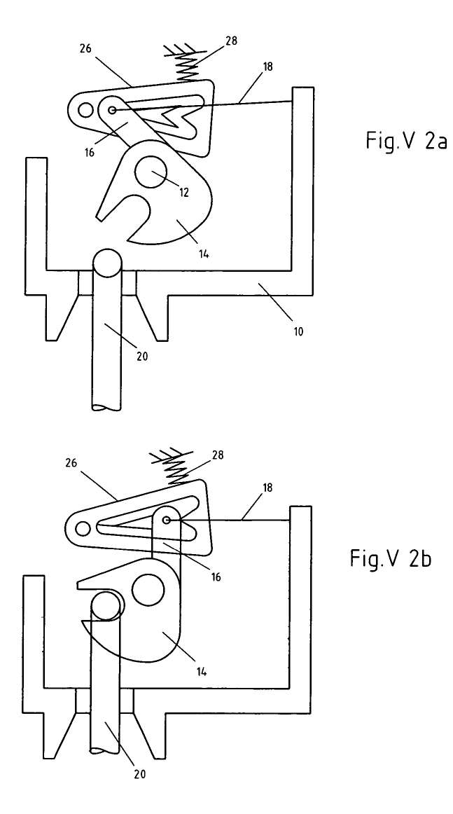

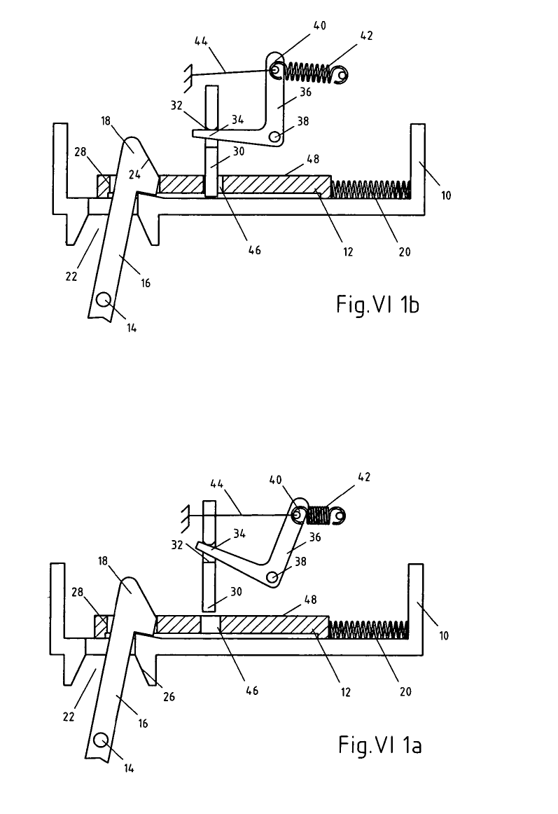

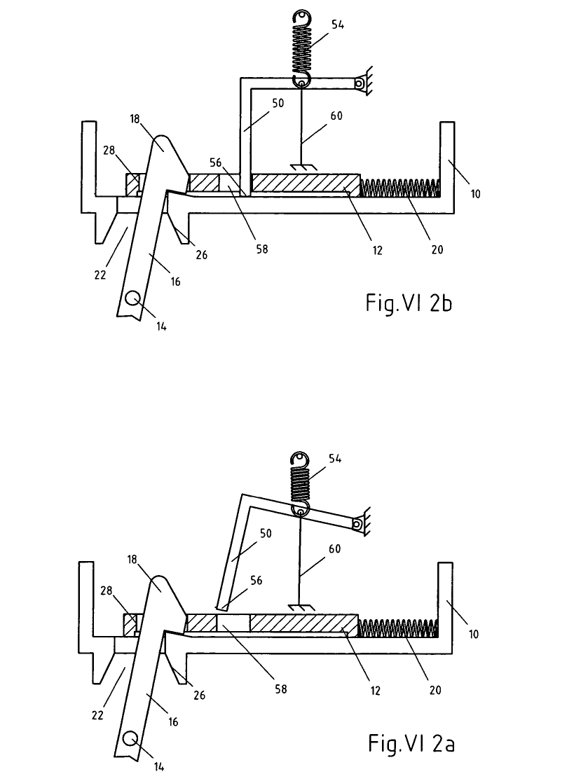

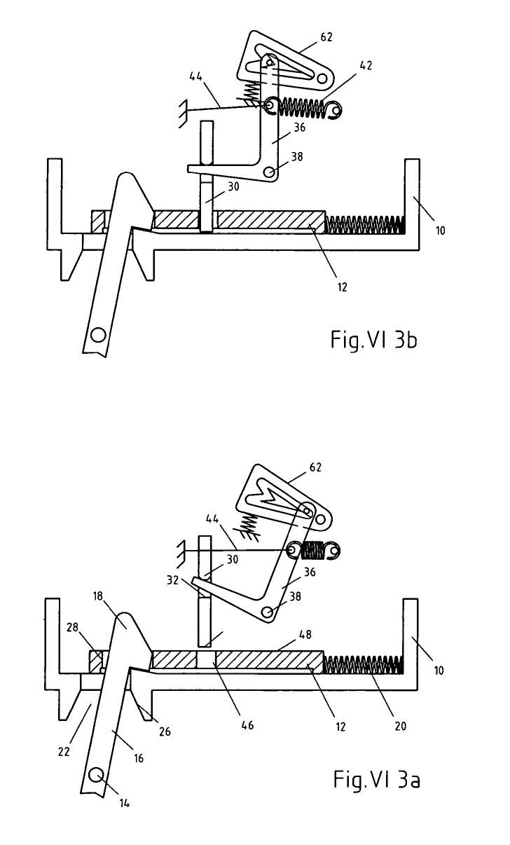

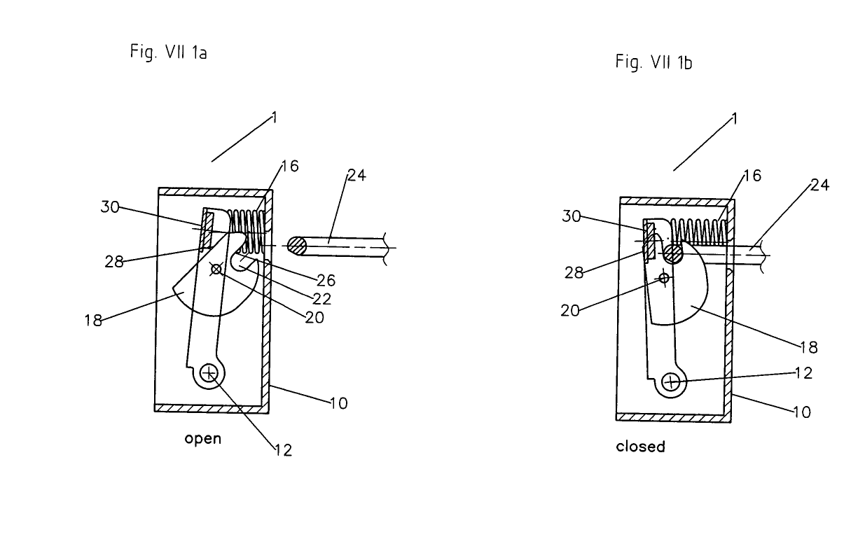

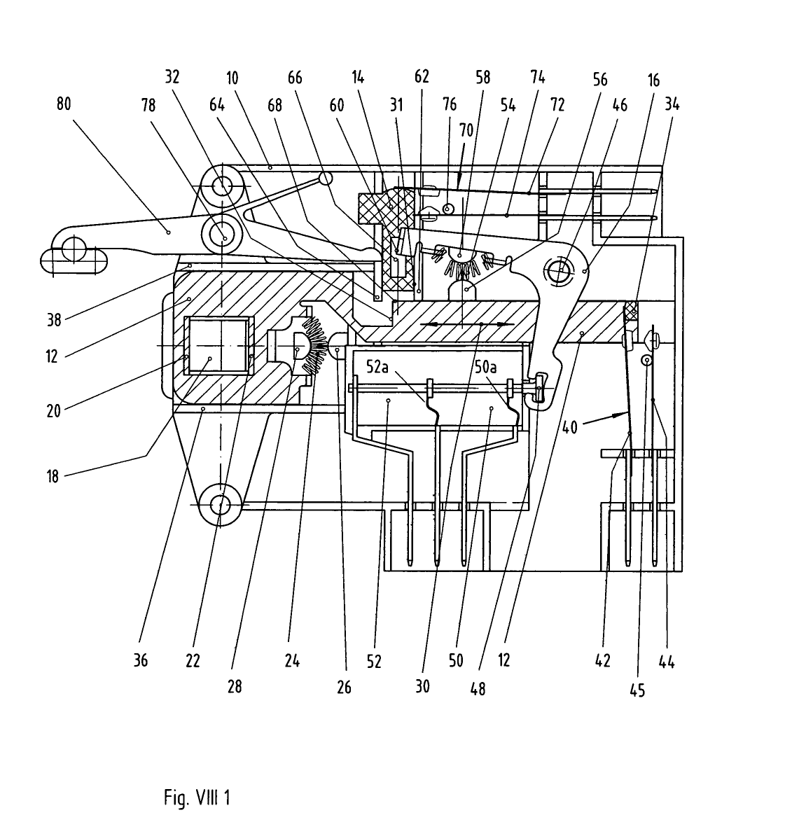

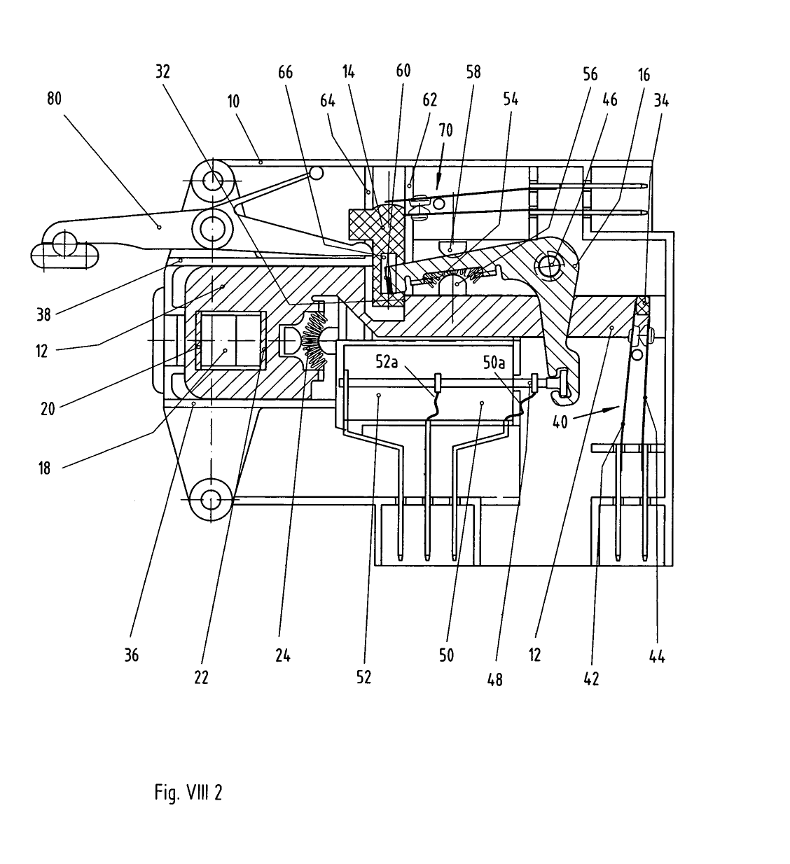

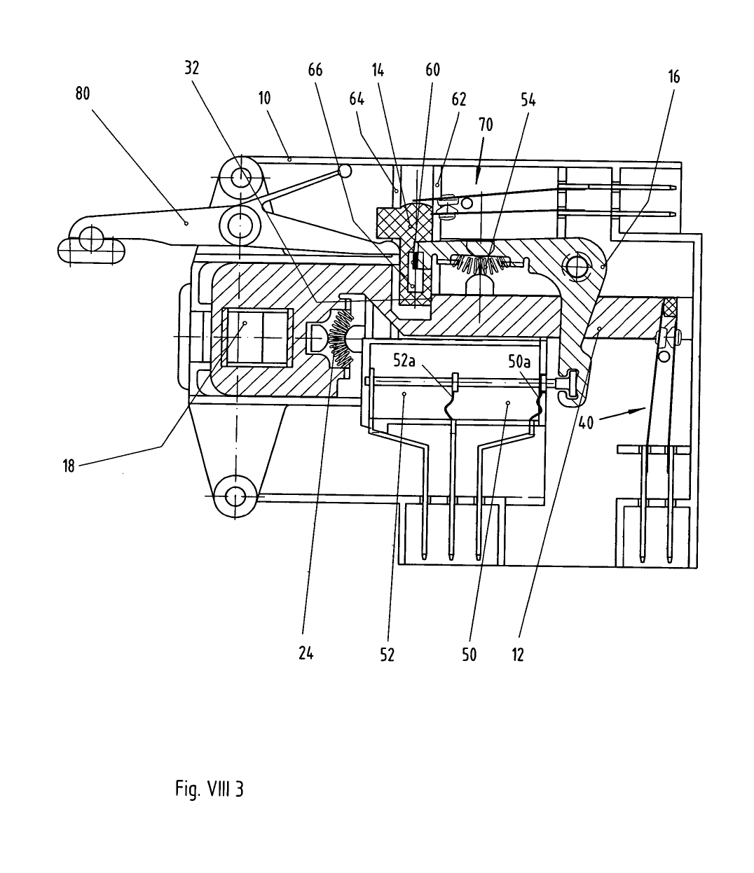

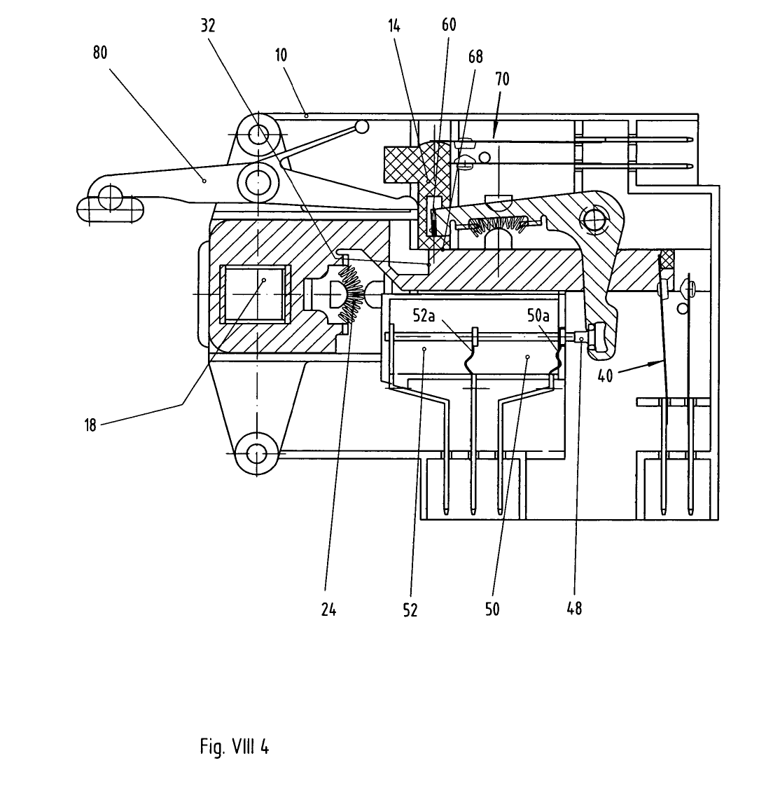

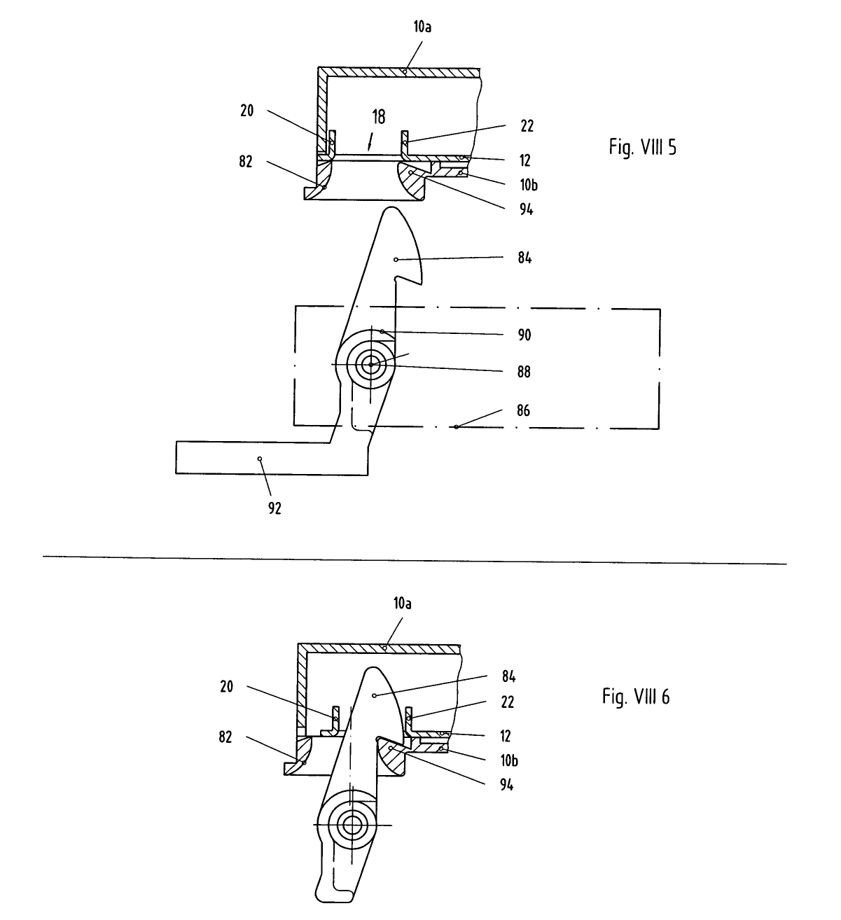

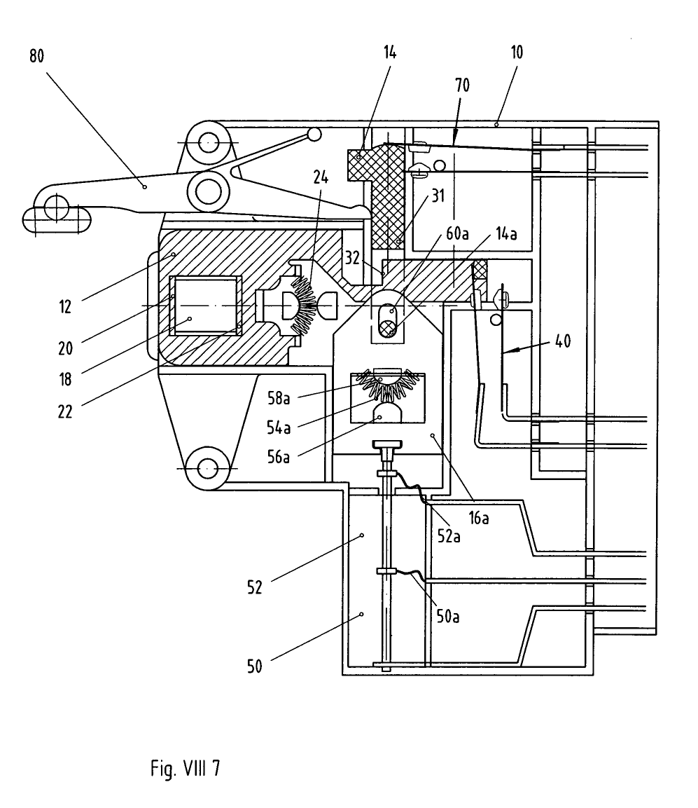

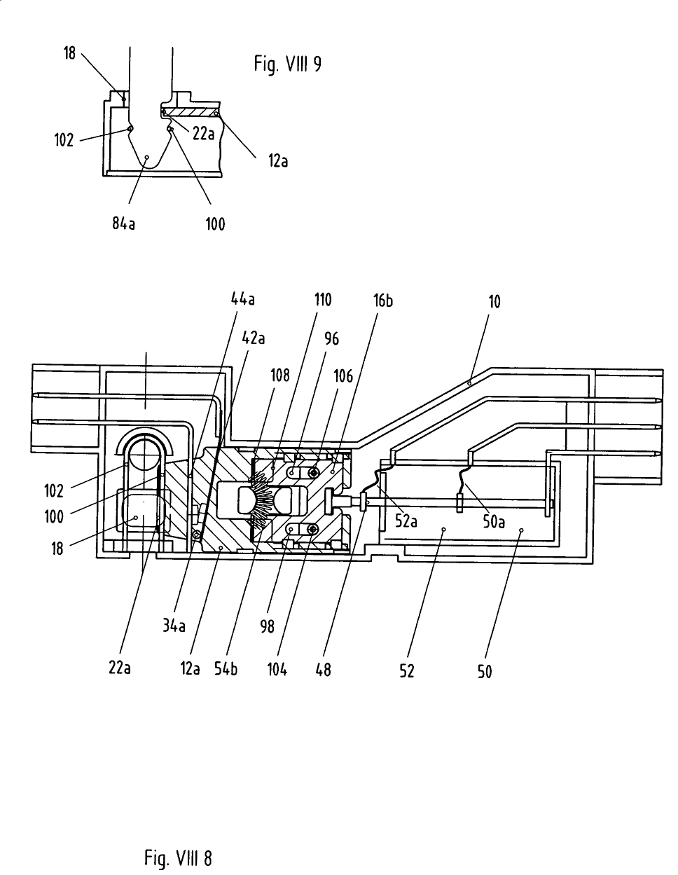

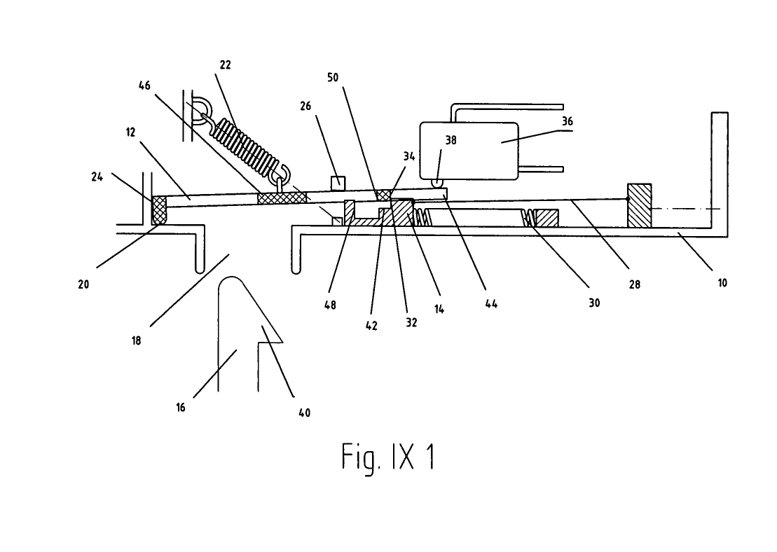

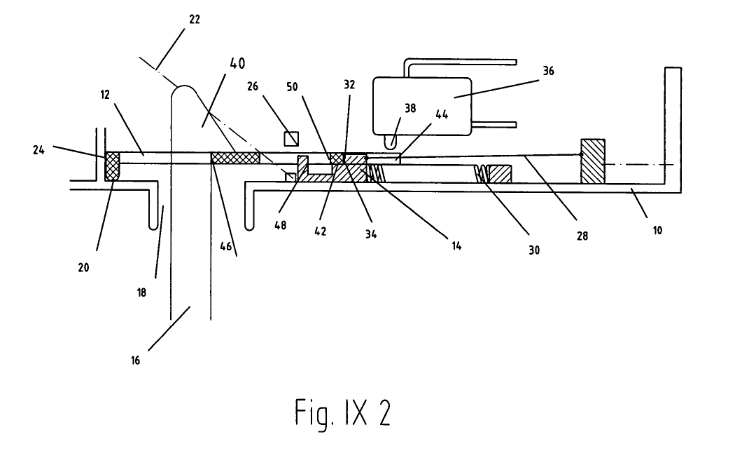

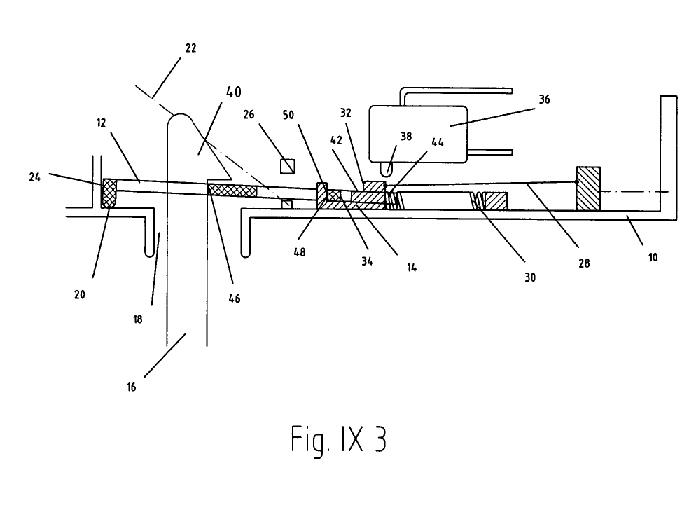

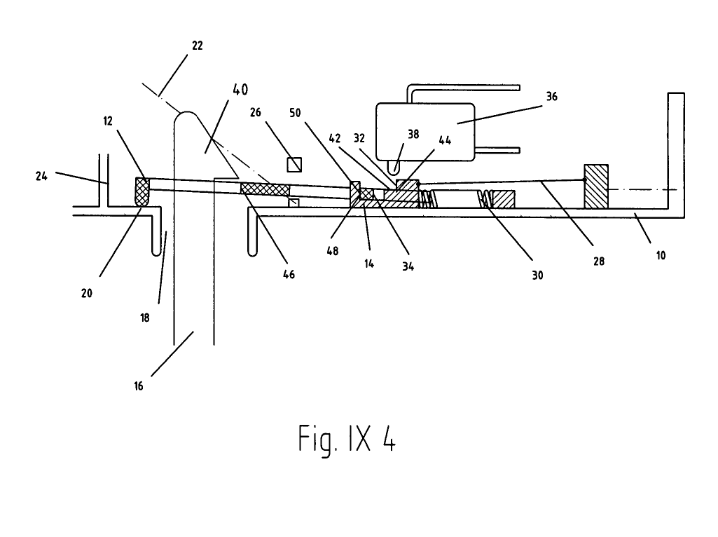

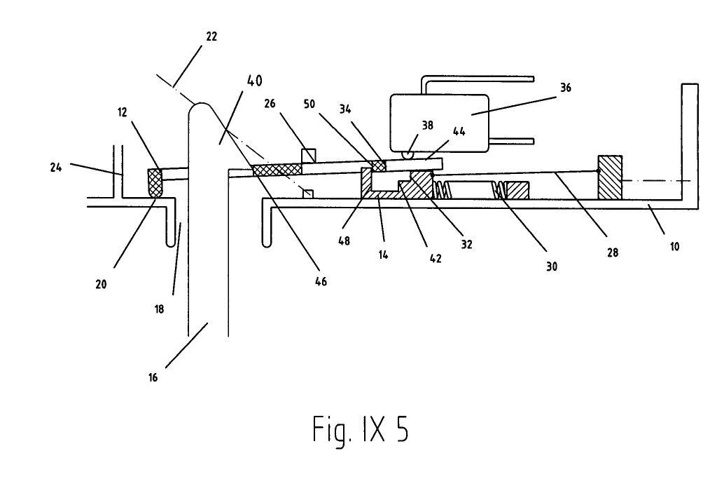

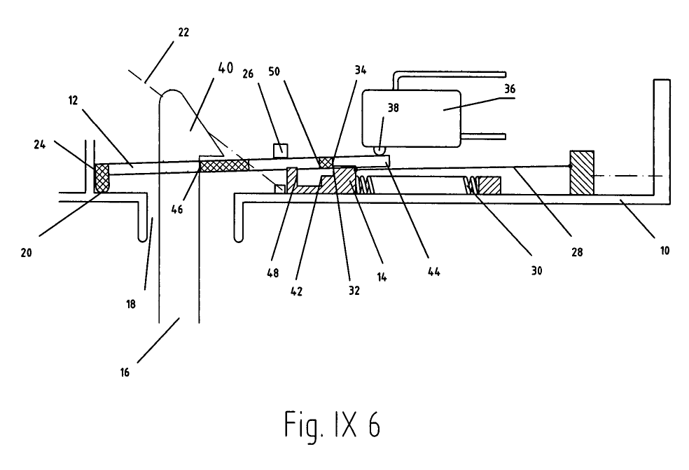

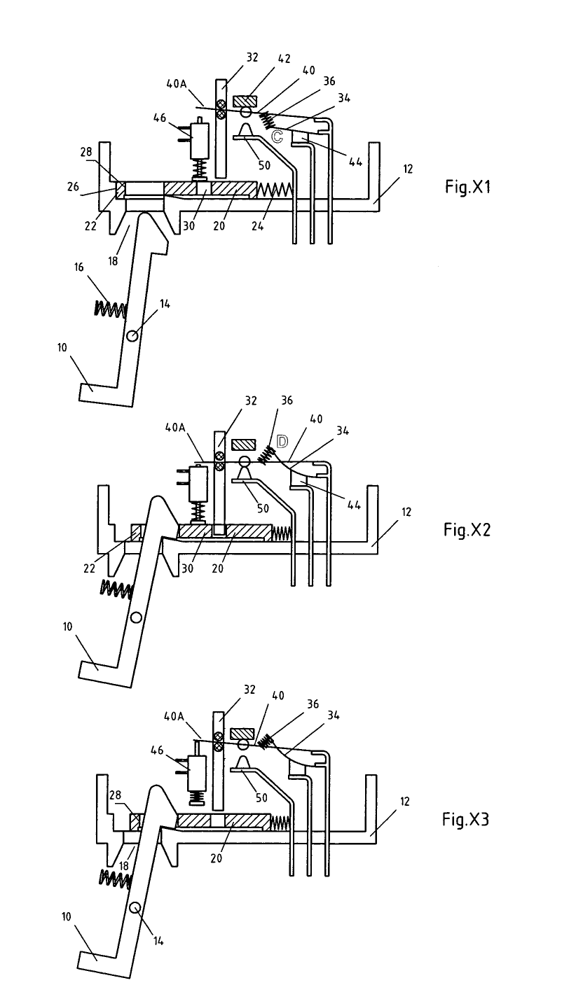

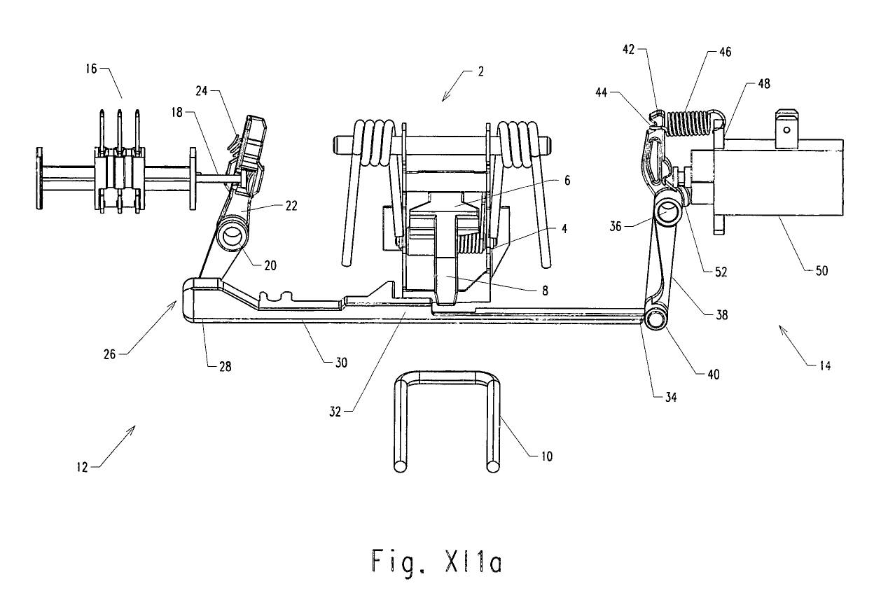

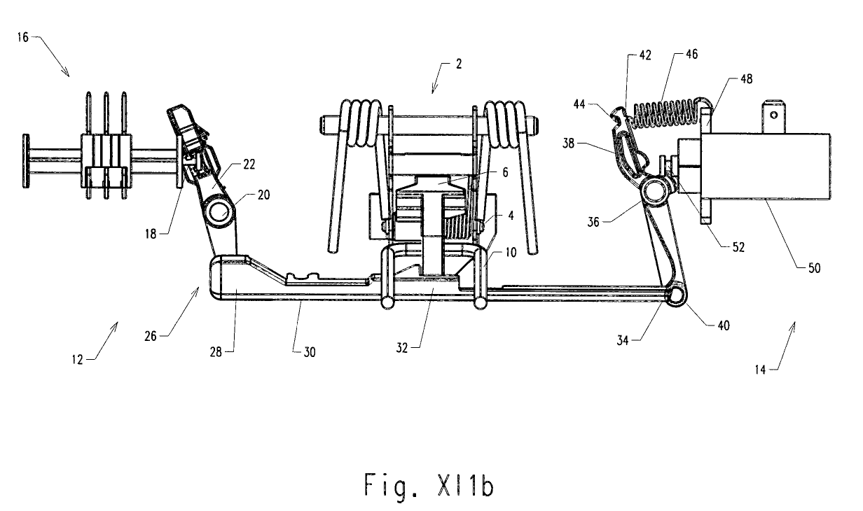

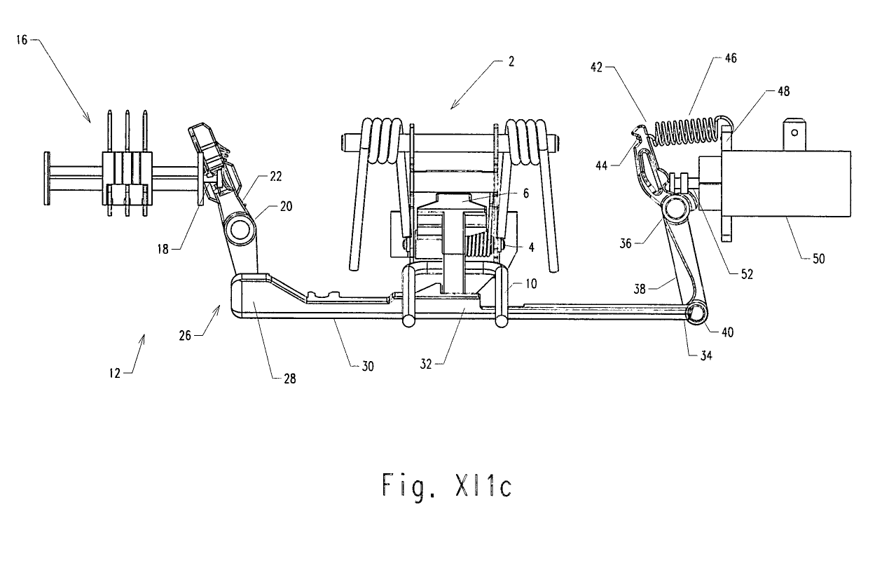

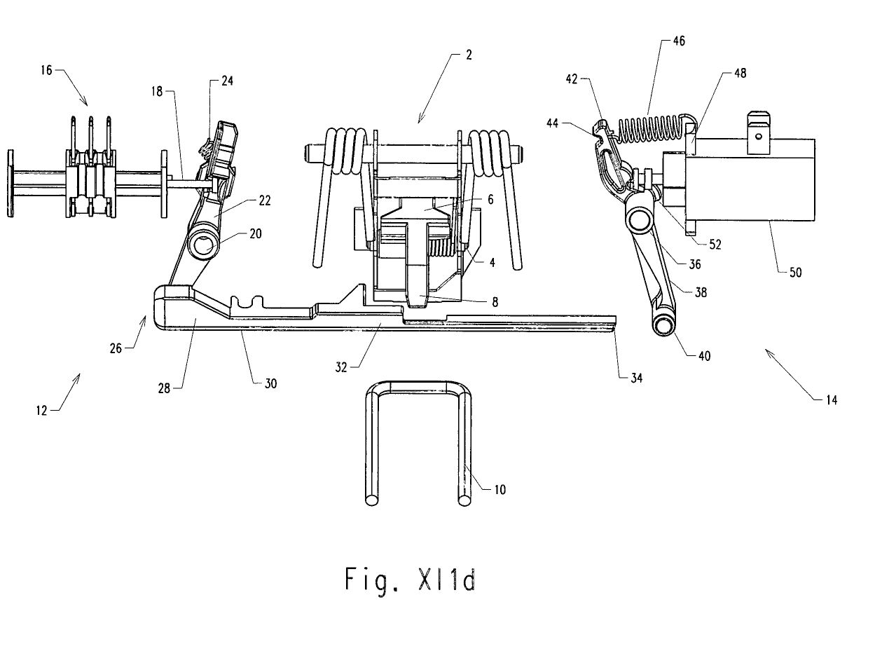

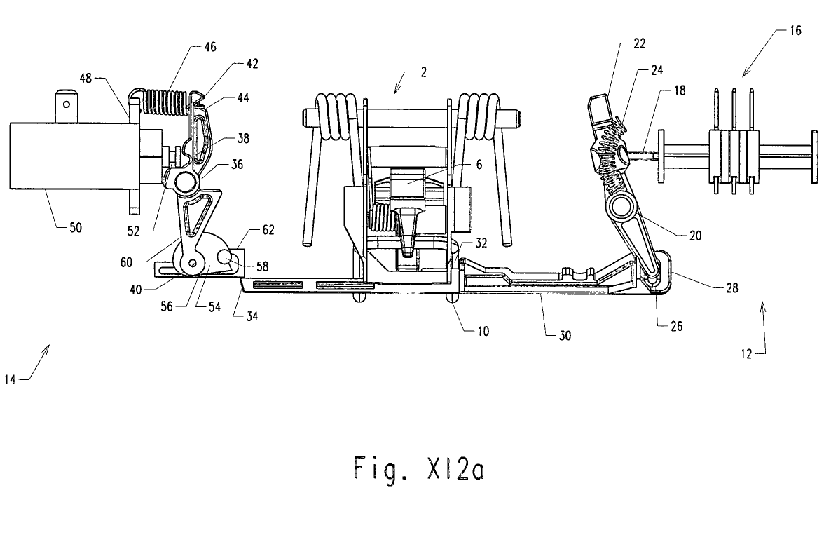

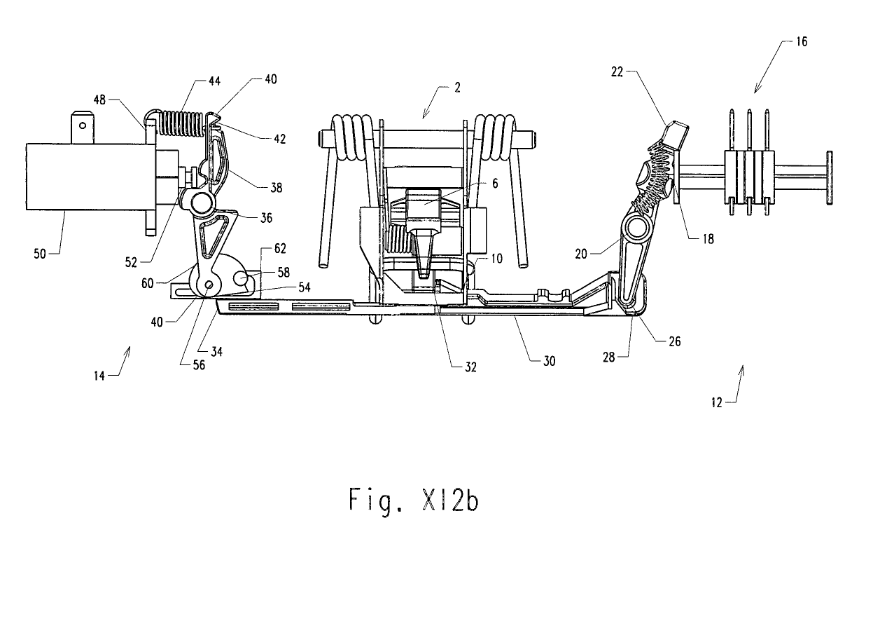

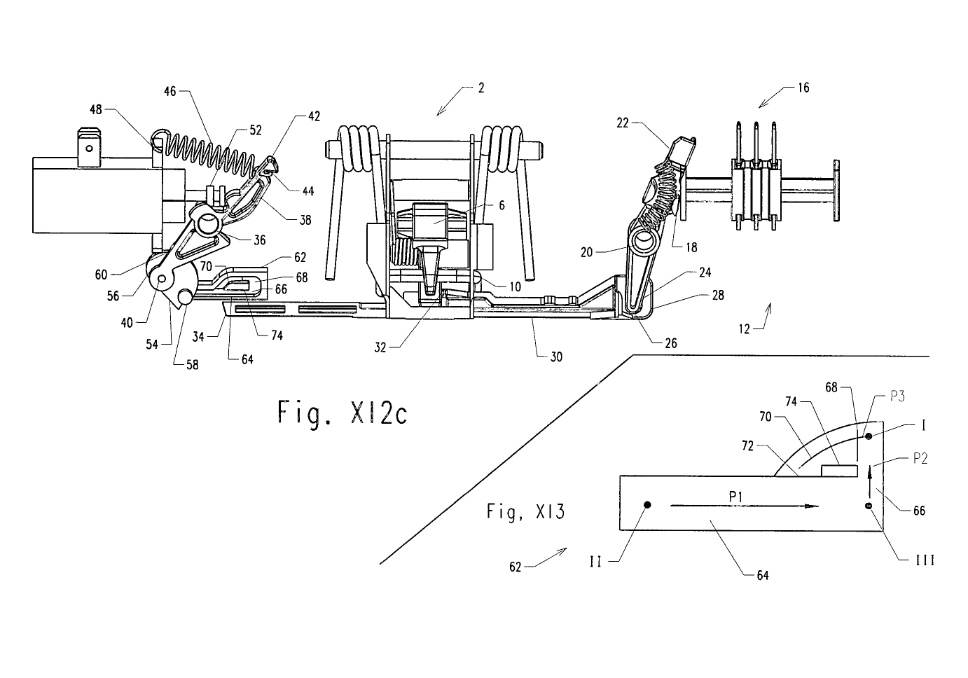

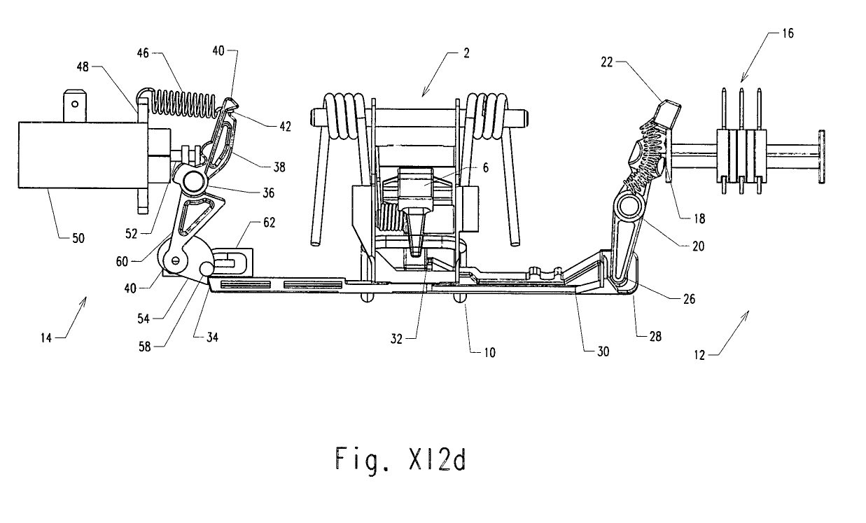

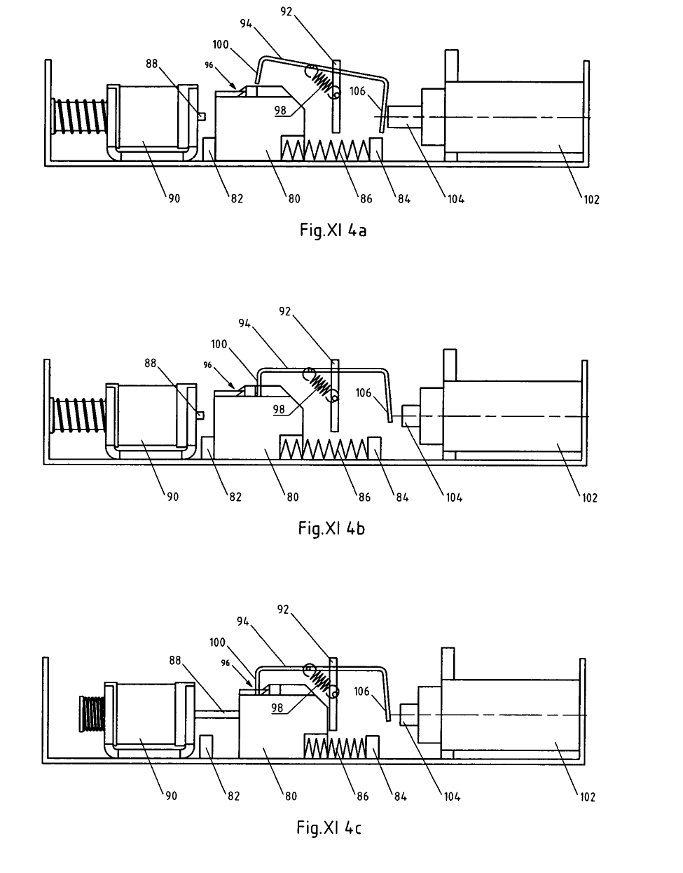

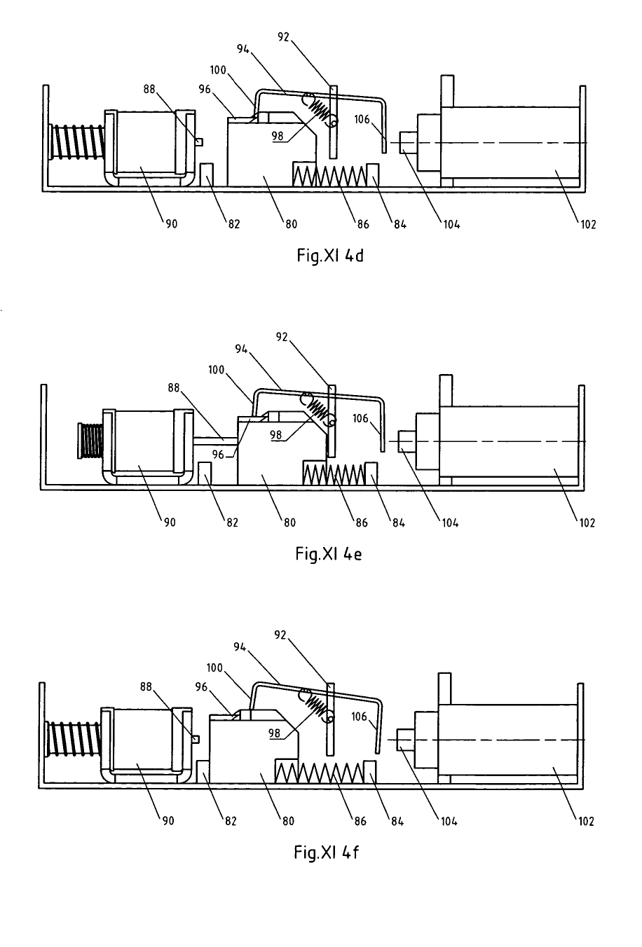

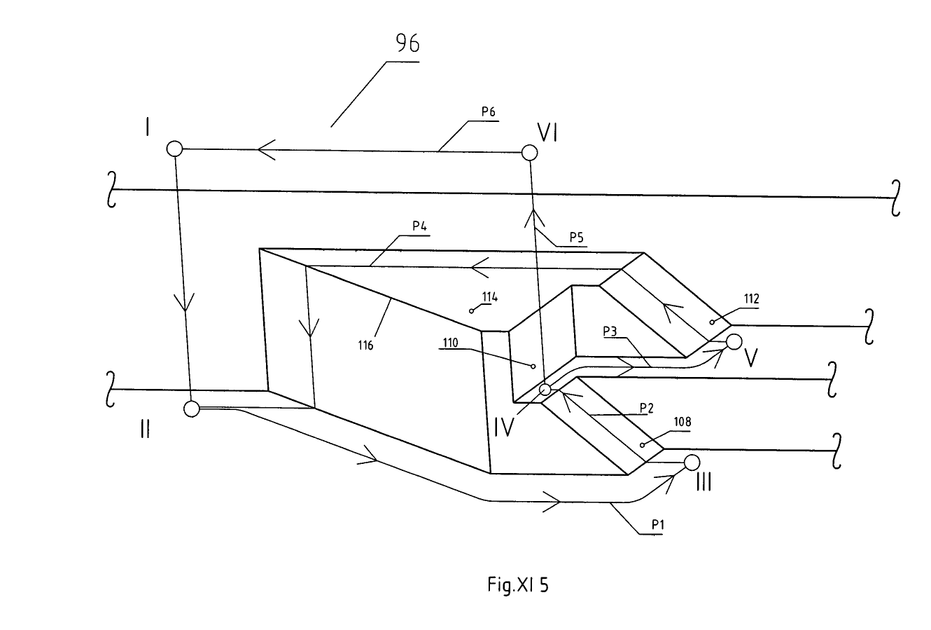

Simultaneously with the excitation of the memory metal actuator 46 the current supply to the memory metal actuator 34 is interrupted so that the it with the compression spring 36 returns into position C shown in FIG. X 1. As soon as the latter is the case the memory metal actuator 46 can be desactivated, and the bolt 48 returns into the position shown in FIG. 1. After sufficient cooling, the memory metal actuator 46 returns to the position shown in FIG. X 1.

Embodiments—Part XI

FIGS. XI 1a to XI Id show a door lock 2 having a gripping device 6, which is rotatably about an axle 4 and has a latch 8 formed therein. The latch 8 cooperates with a bolt nab 10 in such a way that a movement of the bolt nab 10 during closing of a non-illustrated appliance door rotates the gripping device 6 in such a way that the door lock 2 is locked. During opening of the appliance door, a corresponding movement of the bolt nab 10 rotates the gripping device 6 in an opposite direction of rotation to that during closing, with the result that the door lock 2 is unlocked.

FIGS. XI 1a to XI 1d moreover show components 14 to 34 of a blocking and release unit 12 and components 36 to 52 of an emergency release unit 14 for an embodiment of an apparatus for blocking and releasing the door lock 2. The components of the blocking and release unit 12 and of the emergency release unit 14 are described with reference to FIG. XI 1a. For the description of the operation of said embodiment reference is made to FIGS. XI 1a to XI 1d.

The blocking and release unit 12 comprises an electromagnetic actuator 16 and a magnetic plunger 18 movable by the latter. According to FIGS. XI 1a to XI 1d the magnetic plunger 18 is movable to the left and to the right. The magnetic plunger 18 engages into one end of a lever 22, which is rotatably about an axle 20. The lever 22 is a bi-stable element, which may be preloaded by a spring 24 into two positions, which are described below. The spring 24 here is moreover disposed in such a way that forces needed for crossover of the lever 22 between its positions are provided at least partially by the spring 24. This is achieved in that potential energy stored in the spring 24 during a movement of the lever 22 is converted, after a snap point is overcome, into kinetic energy in order to provide forces in the original direction of motion of the lever 22.

Designing the lever 22 as a bi-stable element reduces the energy required for the electromagnetic actuator 16 because the electromagnetic actuator 16 is not needed to hold the lever 22 in one of the positions. On the other hand, the lever 22 may alternatively be a conventional lever if the electromagnetic actuator 16 and/or the magnetic plunger 18 and/or other non-illustrated devices guarantee that the lever 22 assumes and maintains positions which, as is described below, are necessary for the operation of the blocking and release unit 12.

An end of the lever 22 lying opposite the end workingly connected to the magnetic plunger 18 is connected by means of a hinged connection 26 to an end 28 of a blocking and release element 30. The blocking and release element 30, which here takes the form of a slide, has a blocking surface 32 in the region of the door lock 2. An end 34 lying opposite the end 28 is used for actuation of the blocking and release element 30 by means of the emergency release unit 14 in order that in an abnormal operating state of an electrical appliance, the appliance door of which may be locked and unlocked by means of the door lock 2, the blocking and release unit 12 may, in the manner described below, release the door lock 2 for unlocking.

The emergency release unit 14 comprises a lever 38, which is rotatably about an axle 36 and which in the event of abnormal operation of the electrical appliance may with one end 40 by virtue of a working connection to the end 34 actuate the blocking and release unit 12. An end 42 lying opposite the end 40 has a nose 44, which is used for fastening one end of a tension spring 46. The other end of the tension spring 46 is fastened to an attachment flange 48, which according to FIGS. XI 1a to XI 1d is provided on a housing (not denoted) of a one-way memory metal actuator 50. Instead of the attachment flange 48 it is possible to use a different fastening element, which is provided e.g. on a frame for individual, some or all of the components shown in FIGS. XI 1a to XI 1d.

The memory metal actuator 50 may be heated by supplying electrical or thermal energy, i.e. above its upper threshold temperature, in order to move a displaceable member 52 connected thereto. In dependence upon a position of the displaceable member 52 caused by activation of the memory metal actuator 50 a working connection to the lever 38 may be established in order to enable the “emergency” release, described below, of the door lock 2 in an abnormal operating state of the electrical appliance.

In the view shown in FIG. XI 1a, the appliance door is open and so the bolt nab 10 is not in engagement with the latch 8. The door lock 2 is accordingly unlocked. Furthermore, the blocking and release unit 12 is in a release state and the emergency release unit 14 is in an idle state.

In said case, the lever 22 is held by the spring 24 in the position for the release setting, with the result that the blocking and release element 30 and in particular the blocking surface 32 are so positioned that, for closing and locking the appliance door, the bolt nab 10 may be introduced into the latch 8 and the gripping device 6 may be rotated.

In the idle state of the emergency release unit 14 the memory metal actuator 50 is not activated, with the result that the displaceable member 52 is situated in the neutral position shown in FIG. XI 1a. The tension spring 46 holds the lever 38 in the position shown there, wherein the displaceable member 52 and/or the end 34 serve as a stop for the lever 38. Such a stop may alternatively be provided by a separately constructed stop element (not shown). Given the use of such an external stop for the lever 38, contact of the latter with the displaceable member 52 and/or the end 34 in the position shown in FIG. XI 1a is not necessary but is established only, as described below, by a movement of the blocking and release element 30 and/or of the displaceable member 52. When upon closing of the appliance door the bolt nab 10 by virtue of rotation of the gripping device 6 locks the door lock 2, the position of the door lock 2 and of the bolt nab 10 shown in FIG. XI 1b arises. In order to secure the door lock 2 against non-permitted/undesirable unlocking, the blocking and release unit 12 is activated to block the door lock 2 or, more precisely, to prevent rotation of the gripping device 6. In said case, it is provided that the blocking and release unit 12 is actuated substantially immediately at the same time as locking of the door lock 2, after a defined length of time or in dependence upon an operating state of the electrical appliance.

In order to actuate the blocking and release unit 12, i.e. assume the position shown in FIG. XI 1b, at the time, at which the door lock 2 is to be blocked, the electromagnetic actuator 16 is activated. The magnetic plunger 18 is therefore moved, in FIG. XI 1b, to the left so that the lever 22 is rotated about the axle 20 into the position shown there and is held in said position by the spring 24 and/or the magnetic plunger 18.

The rotation of the lever 22 effects a displacement of the blocking and release element 30 to the right, with the result that the blocking surface 32 assumes a position, which prevents a rotation of the gripping device 6 needed to unlock the door lock 2. In said case, depending on the respective manufacturing tolerances minor movements of the gripping device 6 may still be possible but rotations, which are required for actually unlocking the door lock 2, are prevented by the blocking surface 32.

The movement of the blocking and release element 30 to the right rotates the lever 38 anticlockwise because of contact of the end 34 with the end 40. This leads to an excursion of the tension spring 46. The position of the displaceable member 52 in said case has not altered compared to the position shown in FIG. XI 1a. The reason for this is that in said state the memory metal actuator 50 has not yet been activated or the supply of energy, e.g. radiation for heating, has not yet effected the change of the memory metal actuator 50 needed for actuation of the displaceable member 52.

In the present case, the memory metal actuator 50 may be activated, i.e. supplied with energy, substantially at the same time as the electromagnetic actuator 16 or after a defined time delay.

Alternatively it is provided that the memory metal actuator 50, prior to activation of the electromagnetic actuator 16, is activated in such a way that, prior to a displacement of the blocking and release element 30, the displaceable member 52 is displaced to the left. In said case, the lever 38 may assume the working position shown in FIG. XI 1b prior to an actuation by the blocking and release unit 12.

Once the blocking and release element 30 has been moved in the previously described manner to the right and the memory metal actuator 50 has been heated such that the displaceable member 52 is moved to the left, the state illustrated in FIG. XI 1c arises. In said state, the door lock 2 is locked and blocked by virtue of the blocking and release unit 12 being in a blocking state, wherein the displaceable member 52 contacts the lever 38. In said case, the state—referred to hereinafter as the working state—of the emergency release unit 14 and in particular the position of the displaceable member 52 are maintained in that the memory, metal actuator 50 remains activated, wherein the energy needed for said purpose may be supplied continuously or at predetermined times and/or during predetermined periods of time.

When in a normal operating state of the electrical appliance the appliance door is to be opened again, the electromagnetic actuator 16 is actuated in such a way that the magnetic plunger 18 is moved to the right. The lever 22 with the participation of the spring 24 is therefore rotated into the position shown in FIG. XI 1d and held there by the spring 24. Consequently, because of the hinged connection 26 the blocking and release element 30 is displaced to the left. The blocking surface 32 therefore assumes a position, in which it is possible, by virtue of opening of the appliance door and the movement of the bolt nab 10 caused thereby, to rotate the gripping device 6 and therefore unlock the door lock 2. Such a state, in which the blocking and release unit 12 is situated in its release state, the door lock 2 is unlocked and there is no working connection between the bolt nab 10 and the latch 8, is shown in FIG. XI 1d.

Substantially at the same time as the activation of the electromagnetic actuator 16 needed for release, the energy supply for the memory metal actuator 50 is interrupted/terminated. In the absence of the energy supply the memory metal actuator 50 cools down and so the displaceable member 52 is moved to the right. The time needed for such a cooling process means that the displaceable member 52 is still in the working position shown in FIG. XI 1d, which corresponds to the position in FIG. XI 1c, when the blocking and release unit 12 has already crossed over into its release state.

When upon cooling of the memory metal actuator 50 the displaceable member 52 moves to the right, the tension spring 46 in dependence upon the movement of the displaceable member 52 effects a rotation of the lever 38 in clockwise direction. The emergency release unit 14 therefore crosses over into its idle state, with the result that the state shown in FIG. XI 1a is retained.

In an abnormal operating state of the electrical appliance, in which the change of state of the blocking and release unit 12 needed to release the door lock 2 cannot be provided, e.g. because of a power failure, the release of the door lock 2 is effected by means of the emergency release unit 14.

When such an abnormal operating state arises, the energy supply of the memory metal actuator 50 is interrupted. Said interruption of the energy supply may be effected in a controlled manner when devices, which are not shown here, detect an operating state, in which it is no longer possible to actuate the blocking and release unit 12 for release of the door lock 2. In the event of a power failure or no energy supply for the electrical appliance, the interruption of the energy supply for the memory metal actuator 50 is effected automatically.

As described above with reference to FIG. XI 1d, because of the missing energy supply the memory metal actuator 50 cools down, with the result that the displaceable member 52 is no longer held in the position shown in FIGS. XI 1c and XI id. This leads to a clockwise rotation of the lever 38 under the action of the tension spring 46. In contrast to the state shown in FIG. XI 1d, in said situation the blocking and release unit 12 is situated in its blocking state shown in FIGS. XI 1b and XI 1c. Consequently, the rotation of the lever 38 effects a displacement of the blocking and release element 30 because of the working connection between the end 40 and the end 34. Said displacement effects a crossover of the blocking and release unit 12 from its blocking state into its release state. As a result, by means of the emergency release unit 14 the state shown in FIG. XI 1a is attained, in which the door lock 2 may be unlocked and the appliance door may be opened.

In a non-illustrated variant of the embodiment of FIGS. XI 1a to XI 1d, instead of the memory metal actuator 50 and the tension spring 46, a further memory metal actuator is used, which in abnormal operating states of the electrical appliance in a manner comparable to the tension spring 46 generates forces, which rotate the lever 38 in the previously described manner in order to bring the blocking and release unit 12 into its release state. For an interruption of the activation of said memory metal actuator and the resultant cooling, the lever 38 is rotated in clockwise direction due to the shape change of the memory metal actuator.

In another non-illustrated embodiment, it is moreover possible to use, instead of tension spring 46, a further one-way memory metal actuator, which in an abnormal operating state of the electrical appliance exerts pressing forces upon the end 42 in order to rotate the lever 38. In said case, in an abnormal operating state of the electrical appliance this memory metal actuator is to be supplied with energy in order to achieve the desired shape change for rotation of the lever 38. To guarantee that in said case this memory metal actuator may effect a crossover of the blocking and release unit 12 into its release state even in the event of a total failure of the energy supply, an energy supply is required, which in such situations may independently supply energy. Such an energy supply may be provided e.g. by a suitably dimensioned storage capacitor, which is charged during normal operation of the electrical appliance.

If in the electrical appliance abnormal operating states may also arise, in which a release of the door lock 2 is not desirable or permissible, a non-illustrated release device for the emergency release unit 14 may be used. Such a release device in dependence upon parameters, which characterize the actual abnormal operating state of the electrical appliance, cooperates with the emergency release unit 14 in such a way that a release of the door lock 2 by the emergency release unit 14 may be prevented. In the present case, the release device may comprise e.g. a lever or pin, which in such operating states mechanically prevents a crossover of the emergency release unit 14 from its working state into its idle state. Depending on the used embodiment of the emergency release unit 14, the release device may in dependence upon the actual abnormal operating state either hold the emergency release unit 14 in its working state through suitable activation or prevent activation of said unit. For operation of the release device it may be necessary to use an energy supply device which, in a comparable manner to the energy supply of the last-described embodiment, may supply energy to the emergency release unit 14 independently of an energy supply for the electrical appliance.

In the embodiment, which is illustrated in FIGS. XI 2a to XI 2d and shown in a mirror-inverted manner in relation to the views of FIGS. XI 1a to XI 1d, the components corresponding to the previously described components are provided with identical reference characters. Said embodiment differs from the previous one in that the emergency release unit 14 comprises an actuating element 54, which is connected by a joint 56 to the end 40.

Fastened to the opposite end of the actuating element 54 to the joint 56 is a pin 58, which is disposed at right angles to the drawing plane. A spring 60 generates a rotatory force, which acts in an anticlockwise direction upon the actuating element 54, and a pressing force acting into the drawing plane. The pressing force may alternatively be provided by an elastic deformation of the actuating member 53 and/or of the lever 38.

Said embodiment further comprises a connecting link guide 62, which is provided e.g. on a fastening frame for the emergency release unit 14. The connecting link guide 62 diagrammatically illustrated in FIG. XI 3 has a non-designated recess, which comprises a substantially horizontally extending guide channel 64 and, connected thereto, a substantially vertically extending guide channel 66, which verges into a guide channel 68, which extends in a curved manner and additionally connects the guide channels 64 and 66. The curved guide channel 68 comprises a slope 70, which extends from the plane of the guide channel 66 in a (gently) ascending manner up to an edge 72. A web 74, which is disposed in the recess, together with the edge 72 forms a marginal boundary of the guide channel 64. The arrows shown in FIG. XI 3 indicate the directions of motion of the pin 58 in the connecting link guide 62 during operation of the emergency release unit 14.

In the state shown in FIG. XI 2a the door lock 2 is unlocked, wherein the blocking and release unit 12 is situated in the release state and the emergency release unit 14 is situated in the idle state. In said case, the pin 58 is situated at the position denoted by I in FIG. XI 3.

FIG. XI 2b shows a state, in which the door lock 2 is locked and the blocking and release unit 12 is situated in its blocking state. Here, in contrast to the-embodiment described with reference to FIGS. XI 1a to XI 1d, the crossover of the blocking and release unit 12 into the blocking state does not cause an actuation of the lever 38. Rather, here the lever 38 is rotated when the displaceable member 52 has moved to the right because of activation of the memory metal actuator 50.

A movement of the displaceable member 52 effects a rotation of the lever 38 in clockwise direction, wherein the pin 58 is moved in the curved guide channel 68 from the position I in the direction indicated by the arrow P1 to the position II (see FIG. XI 3). During said movement the pin 58 is guided by the slope 70 up to the edge 72, behind which it jumps on account of the pressing force of the spring 60 onto the plane of the base surface of the guide channel 64. When the pin 58 is situated at the position II shown in FIG. XI 3, the emergency release unit 14 has crossed over into its working state shown in FIG. XI 2c.

During normal operation of the electrical appliance the door lock 2 is, as described above, released for unlocking because of a crossover of the blocking and release unit 12 into the release state. A crossover of the emergency release unit 14 into its idle state owing to an interruption/termination of its energy supply, in combination with the connecting link guide 62, causes a movement of the actuating element 54, which corresponds to the movement of the actuating element 54 described below for an abnormal operating state of the electrical appliance. In said case, unlike the subsequently described release of the door lock 2 in an abnormal operating state of the electrical appliance, the movement of the actuating element 54 does not effect a release.

As described above, in an abnormal operating state of the electrical appliance the energy supply of the memory metal actuator 50 is interrupted/terminated so that, because of the resultant cooling, the displaceable member 52 is moved to the left by the tension spring 46. The lever 38 is accordingly rotated anticlockwise, with the result that the actuating element 54 is moved by the pin 58, which is guided in the guide channel 64, in the direction of the part P1 shown in FIG. XI 3 in the direction of the position III. During said movement, as may be seen in FIG. XI 2d, the actuating element 54 contacts the end 34 of the blocking and release element 30 and moves the latter to the right. Once the working connection between the actuating element 54 and the end 34 has been established, the further movement of the actuating element 54 towards the position III (see FIG. XI 3) effects a crossover of the blocking and release unit 12 into its release state, as described above.

Because of the boundary of the guide channel 64 formed by the edge 72 and by the web 74, the pin 58 is guided in said guide channel to the position III. When the pin 58 is situated at the position III, i.e. at the transition between the guide channel 64 and the guide channel 66, the spring 60 effects a rotation of the actuating element in an anticlockwise direction and hence a movement in the direction of the arrow P2 to the position I. The emergency release unit 14 is then situated in the idle state illustrated in FIG. XI 2a.

One advantage of said embodiment is that for blocking of the door lock 2 only the forces needed for actuating/moving the blocking and release unit 12 have to be generated by the electromagnetic actuator 16 and/or the spring 24. Forces needed for rotating the lever 38 counter to the action of the tension spring 46 are in said case not provided by the blocking and release unit 12. This may be advantageous in terms of the dimensioning of the electromagnetic actuator 16 and/or of the spring 24.

A further advantage is that the emergency release unit 14 operates substantially independently of the blocking and release unit 12. In said case, therefore, reliable blocking of the door lock 2 is guaranteed even when the emergency release unit 14 is not working properly, e.g. when because of a defect of the memory metal actuator 50 the working state is maintained.

In the embodiment illustrated in FIGS. XI 4a to XI 4f, the function of the blocking and release element 30 of FIGS. XI 1 and XI 2 is provided by a locking slide 80. In FIGS. XI 4a, XI 4b and XI 4f the locking slide 80 is situated in a release position, in which a door lock (not shown here) may be unlocked. In the release position the locking slide 80 contacts a stop 82, wherein a compression spring 86 disposed between the locking slide 80 and a further stop 84 secures the locking slide 80 in the release position. Here, said securing function of the compression spring 86 is only one feature because the compression spring 86, as described below, is also used to bring the locking slide 80 from a blocking position described below into the release position both during normal operation and during abnormal operation of an electrical appliance, in which said embodiment is used.

The locking slide 80 is displaceable and actuable by means of an actuating member 88 of an electromagnetic actuator 90. The function of the electromagnetic actuator 90 substantially corresponds to the function of the electromagnetic actuator 16 and is used to bring the locking slide 80 out of the release position into a blocking position shown in FIG. XI 4d.

A detent pawl 94, which is disposed movably and rotatably on an axle 92, cooperates with a connecting link guide 96 disposed at the top of the locking slide 80. The mode of operation of the detent pawl 94 and the connecting link guide 96 is described in greater detail below with reference to FIG. XI 5. The detent pawl 94 is connected to a tension spring 98, which exerts upon the detent pawl 94 forces which pull one end 100 of the detent pawl 94 in the direction of the surface of the locking slide 80 having the connecting link guide 96. The tension spring 98 is moreover disposed in such a way that its forces may effect, relative to the axle 92, a rotation of the end 100 in anticlockwise direction (i.e. a rotation of the end 100 into the drawing plane of FIGS. XI 4a-4f in the direction of the viewer).

In a comparable manner to the previous embodiments, the emergency release unit in said embodiment comprises a memory metal actuator 102. The memory metal actuator 102 is connected to a displaceable member 104, which through contact with a, here angled, end 106 of the detent pawl 94 holds the latter in the position shown in FIG. XI 4a. In said case, the memory metal actuator 102 is situated in the previously described idle state and so the displaceable member 104 has assumed a neutral position. To achieve said neutral position, if the memory metal actuator 102, in a non-activated state (i.e. in the event of a missing or interrupted energy supply), effects a movement of the displaceable member 104 into said position.

When the locked door lock (not shown here) is to be blocked for operation of the electrical appliance, the electromagnetic actuator 90 is activated so that the actuating member 88 moves the locking slide 80 to the right. The contact between the actuating member 88 and the locking slide 80 required for said purpose may in said case already exist in a non-activated state of the electromagnetic actuator 90 or be established, as illustrated, upon activation of the latter.

Furthermore, to block the door lock it is necessary for the memory metal actuator 102 to be activated, i.e. brought into its working state, in order to bring the displaceable member 104 into the working position shown in FIG. XI 4b. This leads to a working connection between the end 100 and the connecting link guide 96. In dependence upon the technical characteristics of the actuator 102 and in particular the length of time consequently taken to bring the displaceable member 104 into the working position, the instant of activation of the memory metal actuator 102 is to be selected relative to the activation instant for the electromagnetic actuator 90.

When the state shown in FIG. XI 4b exists, the electromagnetic actuator 90 pushes the locking slide 80 into the position shown in FIG. XI 4c, which lies further to the right than the blocking position of the locking slide 80 shown in FIG. XI 4d. Because of the connecting link guide 96, which is described further below, said movement of the locking slide 80 beyond the blocking position is necessary in order to establish a working connection between the end 100 and the connecting link guide 96, which holds the locking slide 80 in the blocking position according to FIG. XI 4d. Such a movement of the locking slide 80 may no longer apply when other suitable connecting link guides are used.

Once the electromagnetic actuator 90 has brought the locking slide 80 into the position, which is shown in FIG. XI 4c and may be defined e.g. by the length of the actuating member 88 and/or by a stop (not shown here), the electromagnetic actuator 90 is deactivated. The actuating member 88 accordingly releases the locking slide 80, which is moved by the compression spring 86 to the left and into the blocking position shown in FIG. XI 4d. In said case, the blocking position is maintained through cooperation of the end 100 of the detent pawl 94 with the connecting link guide 96.

In order during normal operation of the electrical appliance to release the door lock again for unlocking, the electromagnetic actuator 90 is activated once more. The actuating member 88 therefore moves the locking slide 80 from its blocking position to the right into the position shown in FIG. XI 4e. Because of the used connecting link guide 96 said position corresponds substantially to the position shown in FIG. XI 4c. Said movement of the locking slide 80 is also necessary here in order to achieve a working connection between the end 100 of the detent pawl 94 and the connecting link guide 96, which connection is needed for a crossover of the locking slide 80 from the blocking position into the release position.

When the locking slide 80 is in the position shown in FIG. XI 4e, the electromagnetic actuator 90 is deactivated and, as a result of a movement of the actuating member 88 to the right, the locking slide 80 is released. Once the locking slide 80 has been released, the compression spring 86 moves the locking slide 80 to the left, wherein because of the design of the connecting link guide 96 the detent pawl 94 assumes the position shown in FIG. XI 4f, which is needed here for a crossover of the locking slide 80 into the release position.

In the state illustrated in FIG. XI 4f the door lock is released for unlocking. As mentioned above with reference to the memory metal actuator 50, the memory metal actuator 102 is deactivated substantially at the same time or after a defined length of time. This causes a movement of the displaceable member 104 to the left, thereby resulting in the state shown in FIG. XI 4a.

In order in an abnormal operating state of the electrical appliance to release the locked door lock for unlocking, i.e. effect a crossover from the state shown in FIG. XI 4d into the state shown in FIG. XI 4a, the memory metal actuator 102 is used. In dependence upon the actually existing abnormal operating state of the electrical appliance the memory metal actuator 102 is deactivated. Said deactivation may arise, e.g. in the event of a power failure, inherently from the abnormal operating state or may be effected in a controlled manner if, for example, an faulty operating sequence has occurred, in which an unlocking of the door lock is necessary or desirable.

The deactivation of the memory metal actuator 102 leads to a displacement of the displaceable member 104 to the left. In said case, the displaceable member 104 actuates the end 106 of the detent pawl 94 in such a way that the latter is brought from the position shown in FIG. XI 4d into the position shown in FIG. XI 4a. Said change of position of the detent pawl 94 effects a release of the locking slide 80 in the absence of a working connection between the end 100 and the connecting link guide 96. The compression spring 86 accordingly moves the locking slide 80 into its release position, with the result that the state shown in FIG. XI 4a is attained. In said state the door lock is released and may be unlocked.

There now follows a detailed description of the connecting link guide 96 with reference to FIG. XI 5. The arrows shown in FIG. XI 5 represent movements of the end 100 of the detent pawl relative to surfaces of the connecting link guide 96.

Starting from the state shown in FIG. XI 4a, the end 100 is situated at the position I. An activation of the actuator 102 effects a movement of the end 100 to the position II, from which the end 100 reaches the position III along the arrow P1 because of an activation of the electromagnetic actuator 90 and the resultant movement of the locking slide 80. The end 100 is situated at the position III when the locking slide 80 is situated in the position shown in FIG. XI 4c. As a result of deactivation of the electromagnetic actuator 90 the locking slide 80 is brought by the compression spring 86 into the position shown in FIG. XI 4d, which according to FIG. XI 5 leads to a movement of the connecting link guide 96 to the right. In said case, the end 100 of the detent pawl 94 moves over an oblique surface 108 to the position IV, where it contacts a surface 110 defining a catch. Because of the working connection between the catch 110 and the end 100 the locking slide 80 is held in the blocking position.

For a crossover of the locking slide 80 into the release position the electromagnetic actuator 90 is, as described above, activated once more. The result is a movement of the connecting link guide 96 according to FIG. XI 5 to the left, wherein the tension spring 98 rotates the detent pawl 94 about the axle 92. The end 100 accordingly moves relative to the connecting link guide along the arrow P3 to the position V. The subsequent deactivation of the electromagnetic actuator 90 releases the locking slide 80, which because of the force generated by the compression spring 86 leads according to FIG. XI 5 to a movement of the connecting link guide 96 to the right. In said case, the end 100 of the detent pawl 94 moves along the arrow P4 over an oblique surface 112 and a substantially horizontally illustrated surface 114 up to an edge 116. Because of the tensile forces generated by the tension spring 98, the end 100 “jumps” downwards after the edge 116 and, because of the movement of the locking slide 80, reaches the position II.

The deactivation of the memory metal actuator 102 effects a movement of the end 100 from the position II into the position I. For a release of the door lock in an abnormal operating state of the electrical appliance the memory metal actuator 102 is, as described above, deactivated in order to actuate the detent pawl 94. Because of the blocking of the door lock effected by the electromagnetic actuator 90, the end 100 of the detent pawl is situated at the position IV. The actuation of the detent pawl 94 by the deactivated memory metal actuator 102 causes a movement of the end 100 in the direction of the arrow P5 to the position VI. Because of the movement of the locking slide 80 under the action of the compression spring 86, the end 100 is moved relative to the connecting link guide in the direction of the arrow P6 up to the position I.

One advantage of the embodiment described with reference to FIGS. XI 4a to XI 4f is that to maintain the blocking state, i.e. the blocking position of the locking slide 80, it is not necessary to hold the electromagnetic actuator 90 in an activated state and/or use a device providing the function of the previously described bi-stable element 22.

We claim

1. Unit for a door latch of a household appliance, comprising
at least one memory metal actuator for generating forces desired during use of the door latch.

2. Unit according to claim 1, comprising
the memory metal actuator for generating forces for locking the door latch when the door latch is in a latched condition, and/or
the memory metal actuator for generating forces for release of the door latch when the door latch is in a latched condition.

3. Unit according to claim 1, comprising
the memory metal actuator for generating forces to cause the door latch in a latched condition starting from an unlatched condition, and/or
the memory metal actuator for generating forces to cause the door latch in an unlatched condition starting from a latched condition.

4. Unit according to claim 1, comprising
the memory metal actuator for generating forces to cause the door latch into an open condition starting from a latched or an unlatched condition, and/or
the memory metal actuator for generating forces to cause the door latch in an unlatched or a latched condition starting from an opened condition.

5. Unit according to claim 1, wherein
the memory metal actuator is adapted for cooperating with a reset unit provided for the door latch.

6. Unit according to claim 1, wherein
the memory metal actuator comprises at least one two-way memory metal and/or at least one one-way memory metal.

7. Unit according to claim 1, comprising
a unit for heating the memory metal actuator above a first given threshold temperature, and/or
a unit for cooling the memory metal actuator below a second given threshold temperature.

8. Unit according to claim 1, comprising
a current or voltage supply connected to the memory metal actuator for an essentially continuous activation of the memory metal actuator, and
a heat generating means being thermically coupled to the memory metal actuator for essentially continuous activation of the memory metal actuator.

9. Unit according to claim 1, comprising
a controlled current or voltage supply being connected to the memory metal actuator for pulse-like activation of the memory metal actuator, or
a PTC element being electrically connected to the memory metal actuator for pulse-like activation of the memory metal actuator.

10. Unit according to claim 1, comprising
a controlled current or voltage supply being connected to the memory metal actuator for pulse-like activation of the memory metal actuator and for essentially continuous maintaining the activation of the memory metal actuator, or
a controlled current or voltage supply being connected to the memory metal actuator for a pulse-like activation of the memory metal actuator and a heat generating means being thermically coupled to the memory metal actuator for essentially continuous maintaining the activation of the memory metal actuator.

11. Unit according to claim 1, comprising
a means cooperating with the memory metal actuator for maintaining an operation condition of the unit and/or the door latch being present in response to an activation of the memory metal actuator.

12. Method for operating a unit for a door latch of a household appliance including at least one memory metal actuator for generating forces desired during use of the door latch, comprising the following steps:
activating the memory metal actuator in order to generate forces for locking the door latch when the door latch is in a latched condition, and/or
activating the memory metal actuator for generating forces for releasing the door latch when the door latch is in the latched condition, and/or
activating the memory metal actuator for generating forces to cause the door latch in a latched condition starting from a unlatched condition, and/or
activating the memory metal actuator for generating forces to cause the door latch in an unlatched condition starting from a latched condition, and/or
activating the memory metal actuator for generating forces to cause the door latch in an open condition starting from a latched or an unlatched condition, and/or
activating the memory metal actuator for generating forces to cause the door latch in an unlatched or a latched condition starting from an opened condition.

13. Method according to claim 12, comprising the following steps:
supplying an essentially constant current or voltage to the memory metal actuator for essentially continuously activating the memory metal actuator, and/or
supplying an essentially constant heat to the memory metal actuator for essentially continuously activating the memory metal actuator.

14. Method according to claim 12, comprising the following steps:
pulse-like activating the memory metal actuator by means of a controlled current or voltage supply being connected to the memory metal actuator, or
pulse-like activating the memory metal actuator by means of a PTC element being electrically connected to the memory metal actuator.

15. Method according to claim 12, comprising the following steps:
pulse-like activating the memory metal actuator and essentially continuously maintaining the activation of the memory metal actuator by means of a controlled current or voltage supply being connected to the memory metal actuator, or
pulse-like activating the memory metal actuator by means of a controlled current or voltage supply being connected to the memory metal actuator and essentially continuously maintaining the activation of the memory metal actuator by means of a heat generating means being thermically coupled to the memory metal actuator.

16. Method according to claim 12, comprising
maintaining the operation condition of the unit and/or the door latch existing in response to an activation of the memory metal actuator by means of means cooperating with the memory metal actuator.

17. Door latch for a household appliance, comprising
the unit according to one of the claims 1 to 11.

18. Control unit for a door latch of a household appliance, which
is adapted for controlling of the unit according to one of the claims 1 to 11.

19. Control unit for a door latch of a household appliance, which
is adapted for carrying out the steps of one of the claims 12 to 16.
